(19) United States
(12) Patent Application Publication
(10) Pub. No.: US 2011/0242312 A1
(43) Pub. Date: Oct. 6, 2011

(54) INSPECTION SYSTEM AND INSPECTION METHOD

(75) Inventors: Hirokazu SEKI, KANAGAWA (JP); Kenji KOREMURA, KANAGAWA (JP); Makoto TORIZAWA, KANAGAWA (JP); Masanori KOBAYASHI, KANAGAWA (JP); Toshiyuki TODOROKI, KANAGAWA (JP); Haruhiko KUSUNOSE, KANAGAWA (JP)

(73) Assignee: LASERTEC CORPORATION, YOKOHAMA-SHI (JP)

(21) Appl. No.: 13/073,130

(22) Filed: Mar. 28, 2011

(30) Foreign Application Priority Data
Mar. 30, 2010 (JP) 2010-078511
Apr. 7, 2010 (JP) 2010-088445
Feb. 22, 2011 (JP) 2011-035751

(51) Int. Cl. G06K 9/00; H04N 7/18

(52) U.S. Cl. 348/125; 382/141; 348/E07.085

(57) ABSTRACT

According to the invention, the surface of the Sic substrate or the epitaxial layer formed on the Sic substrate using the optical apparatus including the differential interference optical system. The reflected light from the surface of the Sic substrate or the epitaxial layer is received by the line sensor (23), and the output of the line sensor is supplied to the processor (11). The processor comprises means for forming the differential interference contrast image of the surface of the Sic substrate. The differential interference contrast image of the surface of the Sic substrate is supplied to the defect detection means in order to detect the defects formed in the substrate. The image of the detected defect is supplied to the defect classification means (36) to classify the type of the defect based on the shape and luminance distribution of the defect image. The defect classification means comprise a first classifying means (50) for classifying the defect image having specific shape and a second classifying means (51) for classifying the defect image having a spot shaped dark image or the luminance distribution of a bright image portion and a dark image portion.

### TECHNICAL FIELD

The present invention relates to an inspection system and inspection method which use an optical system which includes a differential interference optical device so as to optically detect a defect which is present at a silicon carbide substrate (SiC substrate) or an epitaxial layer which is formed on a silicon carbide substrate. Furthermore, the present invention relates to an inspection system which classifies a detected defect.

### Background Art

A method of production of a semiconductor device which uses an epitaxial growth method to form a monocrystalline layer on a monocrystalline substrate and forms a device on the monocrystalline layer thus formed has been developed. In this method of production of a semiconductor device, a silicon carbide substrate is used as the monocrystalline substrate, and a step flow growth method is used to form an epitaxial layer on the silicon carbide substrate. Silicon carbide has superior physical and thermal properties compared with silicon, so a method of production of a device using a semiconductor substrate comprised of a silicon carbide substrate on which an epitaxial layer is formed is extremely useful for production of a high power, low loss semiconductor device.

In the above-mentioned method of production of a semiconductor device, to improve the yield in production and improve the reliability of a device, detection of defects which are present at the silicon carbide substrate and epitaxial layer and classification of the types of defects which are detected are extremely important. In the past, as a method of detection of defects which are present on a silicon carbide substrate (SiC substrate), detection of defects by X-ray topography has been known (for example, see PLT 1). In this X-ray topography defect detection method, there is the advantage that it is possible to nondestructively detect crystal defects which are present at the SiC substrate.

As a method for optical detection of a defect which is formed on an SiC substrate, a laser scattering type defect inspection system has been known (for example, see PLT 2). In this laser scattering type defect inspection system, laser light which is emitted from a laser diode is made to strike the substrate surface at a slant and scattered light produced at the substrate surface is detected by a photodetector. Further, the detected scattered light is used as a basis for defect detection.

As an inspection system for detecting a defect of a phase shift mask, an inspection system which arranges a differential interference optical device in a light path between a light source and an object lens, captures a differential interference contrast image of a phase shift mask, and uses the differential interference contrast image as the basis to detect defects is known (for example, see PLT 3). In this known inspection system, the differential interference contrast image of the phase shift mask which is captured is compared with a standard image and the result of the image comparison is used as the basis to detect defects.
PLT 1: Japanese Patent Publication (A) No. 2009-44083
PLT 2: U.S. Pat. No. 7,201,799
PLT 3: Japanese Patent Publication (A) No. 2002-287327

### SUMMARY OF INVENTION

### Technical Problem

In the above-mentioned defect detection method using X-ray topography, it is possible to detect any crystal defect inside of the substrate. Threading screw dislocations and basal plane defects which are formed in the bulk of the substrate are detected. However, in defect inspection by X-ray topography, a large-scale apparatus is required for emission of the X-rays. Not only that, there are the problems that it takes a long time to detect the defects and the cost of inspection soars.

The laser scattering type defect inspection system detects scattered light which is produced at the substrate surface, so it is possible to detect defects which appear at the substrate surface. However, undesired scattered light strikes the photodetector, so there is the problem that the resolution of defect detection is low and fine defects are difficult to detect. In particular, a laser scattering type inspection system has a low detection sensitivity in the height direction of the sample surface, so there is the problem that fine surface relief defects of several nm to several tens of nm size which are formed on the surface of the SiC substrate are difficult to clearly detect. That is, lattice defects which are formed on the bulk of the SiC substrate appear as surface relief of several nm to several tens of nm size on the substrate surface. Therefore, with laser scattered light type defect detection, there is a limit to the detection of fine defects present on the SiC substrate. There is also a limit in judgment of the category of defects.

Furthermore, an SiC substrate is transparent to the visible region or IR region, so illumination beams pass through the inside of the substrate, are reflected at the back surface of the substrate, and are emitted from the substrate surface. Accordingly, in an inspection system which performs area illumination of the substrate surface, it is necessary to eliminate the effect of light reflected from the back surface of the substrate. As the method for removal of light reflected from the back surface of the substrate, the method of using a special spatial filter may be considered, but the problem arises of the structure of the optical system becoming complicated.

As a “killer defect” which becomes a problem when forming a device on an epitaxial layer which is formed on an SiC substrate, a micropipe defect may be mentioned. If a micropipe defect is formed in an epitaxial layer, the problem arises that not only does the leakage current of the device which is produced increase, but also the withstand voltage falls. Therefore, when using an SiC substrate to produce a device, to improve the yield in production, the ability to detect micropipe defects differentiated from other defects is an urgent task. Further, carrot defects, triangle defects, and other shape defects having specific shapes are also critical killer defects. On the other hand, threading screw dislocation defects, edge dislocation defects, basal plane defects, and other dislocation defects are defects which are specific to the silicon carbide substrate or epitaxial layer, but are not critical defects for device production and are differentiated from killer defects. Therefore, if detected defects could be classified in accordance with the type of defects, it would become possible to obtain data which is extremely advantageous to quality control of a device which is produced. Further, while dislocation defects are not killer defects, if the distribution density becomes high, the problem arises of the characteristics of the device being degraded. Therefore, if the number of occurrences of dislocation defects could be detected for each chip section, it would be possible to obtain information advantageous for quality control.

In a monocrystalline substrate in which an epitaxial layer is formed by step flow growth, the line-shaped defect of “step bunching” sometimes is formed during the growth of the epitaxial layer. This step bunching unavoidably occurs when forming an epitaxial layer by step flow growth. On the other hand, micropipe defects and dislocation defects (crystal defects) differ in causes of occurrence from step bunching, so it is preferable to detect crystal defects differentiated from step bunching. However, when inspecting an SiC substrate on which a large number of step bunching defects are formed on the epitaxial layer, it is extremely troublesome to detect dislocation defects, micropipe defects, and other lattice defects differentiated from the step bunching.

On the other hand, step bunching becomes a cause of poor withstand voltage of the oxide film of a device, so detection of step bunching of the epitaxial layer is important for the improvement of the yield in device production. In particular, it has been reported that a correlation is observed between the distribution density of the step bunching and distribution of occurrence of lattice defects. Measurement of the distribution density of step bunching is extremely important in improvement of the yield of device production. Further, if the distribution density of step bunching at a SiC substrate surface could be detected, it would be possible to select a region with little step bunching or a region where no step bunching is formed for use in device production. Advantageous information for control of the quality of an SiC substrate could be obtained. This would also be advantageous for improving the reliability of a device.

An object of the present invention is to realize an inspection system and inspection method which enable optical detection of a defect present at a silicon carbide substrate or an epitaxial layer which is formed on a silicon carbide substrate.

Furthermore, an object of the present invention is to realize an inspection system and inspection method which enable classification of a detected defect.
Another object of the present invention is to realize an inspection system which enables output of defect distribution data which shows the types of defects and the number of defects which are detected for each chip section at which a device is scheduled to be formed based on the results of defect classification.
Furthermore, another object of the present invention is to realize an inspection system which enables crystal defects and step bunching to be separated and defects to be detected in a state with no step bunching detected.
Furthermore, still another object of the present invention is to provide an inspection system which enables step bunching and other defects to be simultaneously individually detected in parallel.

### Solution to Problem

An inspection apparatus according to a first mode of the invention is comprised of an optical apparatus comprising an optical source for producing an illumination beam, a stage for supporting the silicon carbide substrate to be inspected and being movable along a first direction and a second direction perpendicular to the first direction, an objective lens for projecting the illumination beam onto the epitaxial layer or the silicon carbide substrate arranged on the stage, a differential interference optical system disposed on an optical path between the optical source and the objective lens and for converting the incident illumination beam into two sub-beams which interfere each other and for combining the sub-beams reflected by the surface of the silicon carbide substrate or the epitaxial layer to produce an interference beam, and an imaging device for receiving the interference beam exiting the differential interference optical system; and

a processor comprising an image formation means for receiving the output signals from the imaging device to form a differential interference contrast image of the surface of the silicon carbide substrate or the epitaxial layer, and defect detection means for detecting the defect existing in or on the silicon carbide substrate or epitaxial layer using the formed differential interference contrast image.

The various types of crystal defects which are present at a silicon carbide substrate or an epitaxial layer which is formed on a silicon carbide substrate appear as fine surface relief of several nm to several tens of nm size on the surface of the substrate or the surface of the epitaxial layer. For example, threading screw dislocation defects, basal plane defects, and other dislocation defects appear as pit-shaped defects at the surface of the epitaxial layer. Further, triangle defects, carrot defects, and other shape defect appear on the surface of the epitaxial layer as recessed defects which are relatively large in size and have specific shapes. Further, the scratches which are produced in the polishing process are line-shaped recessed defects of a depth of several tens of nm. In this way, defects which are present at the silicon carbide substrate or epitaxial layer have specific surface shapes. On the other hand, a differential interference optical device can detect surface relief of several nm to several tens of nm size at the sample surface as changes of luminance. Therefore, if capturing an image of the surface of a silicon carbide substrate or the surface of an epitaxial layer using an optical system which includes a differential interference optical device, it is possible to detect various types of images which are present at a silicon carbide substrate or epitaxial layer. Therefore, the present invention captures an image of a surface of a silicon carbide substrate and a surface of an epitaxial layer which is formed on a silicon carbide substrate using an optical system which includes a differential interference optical device and uses the captured differential interference contrast image to detect defects present at the silicon carbide substrate or epitaxial layer.

An inspection apparatus according to a second mode of the invention is comprised of an optical apparatus comprising an optical source for producing an illumination beam, a stage for supporting the silicon carbide substrate to be inspected and being movable along a first direction and a second direction perpendicular to the first direction, an objective lens for projecting the illumination beam onto the epitaxial layer or the silicon carbide substrate arranged on the stage, a differential interference optical system disposed on an optical path between the optical source and the objective lens and for converting the incident illumination beam into two sub-beams which interfere each other and for combining the sub-beams reflected by the surface of the silicon carbide substrate or the epitaxial layer to produce an interference beam, and an imaging device for receiving the interference beam exiting the differential interference optical system; and

a processor comprising an image formation means for receiving the output signals from the imaging device to form a differential interference contrast image of the surface of the silicon carbide substrate or epitaxial layer, defect detection means for detecting the defect existing in or on the silicon carbide substrate or epitaxial layer using the formed differential interference contrast image, and defect classification means for classifying the detected defect using the differential interference contrast image of the detected defect.

The inventors analyzed the differential interference contrast images of various types of crystal defects which are present at a silicon carbide substrate or epitaxial layer and as a result learned that the differential interference contrast images of various types of crystal defects which are present at a silicon carbide substrate or epitaxial layer are captured as defect images which have specific shapes or luminance distributions for the respective crystal defects. That is, screw dislocation defects, basal plane defects, and other various types of dislocation defects appear at the substrate surface or the surface of an epitaxial layer as pit shapes. Their differential interference contrast images are captured as specific contrast images combining high luminance image parts and low luminance image parts. Further, differential interference contrast images of triangle defects, carrot defects, and other shape defects which are formed on the epitaxial layer are captured as relatively large size low luminance images having triangular shapes or other specific shapes. Further, micropipe defects are hollow shaped holes. Light reflected from the bottom of a hollow hole will not strike a photodetector, so the hole is captured as a spot-shaped low luminance image. Furthermore, a bump defect is also captured as a specific differential interference contrast image. Therefore, dislocation defects, shape defects, micropipe defects, bump defects, and various other defects can be differentiated from other defects based on their respective differential interference contrast images. Based on such results of analysis, in the present invention, a captured differential interference contrast image is used as the basis to detect a defect and the captured differential interference contrast image is used to classify the detected defect. If the detected defect can be classified, information relating to the cause of occurrence of the defect can be obtained and advantageous quality control information relating to the formation of the silicon carbide substrate and epitaxial layer can be obtained.

In a preferable embodiment of the inspection apparatus, the processor further comprises mapping means producing a map information for assigning to the silicon carbide substrate a plurality of chip sections on which each device is scheduled to be formed, respectively, and defect distribution data producing means for producing defect distribution data showing the class of the detected defect or the class and the number of the detected defects every each chip section using the classification result and the map information.

As explained above, when using an inspection system which includes a differential interference optical device so as to inspect a silicon carbide substrate or epitaxial layer, it is possible to judge the type of defect from the differential interference contrast image of the detected defect. Therefore, the present invention uses map information which divides the silicon carbide substrate to be inspected into a plurality of chip sections at which individual devices are scheduled to be formed so as to form defect distribution data which shows, for each chip section, the category of defect or the type of the defect and number of the same which are detected utilizing the results of classification of the defect classifying means. If defect distribution data can be obtained, quality control data of the individual chip sections of a silicon carbide substrate can be obtained, so the yield of production of a device can be improved.

In the present invention, it is possible to use a differential interference contrast image of defects to classify detected crystal defects into defects critical to device production, that is, killer defects, and other defects. That is, triangle defects and other shape defects and micropipe defects are killer defects critical to device production. If a device is formed at a location where such killer defects are present, there is a high possibility of the device becoming an inferior product. As opposed to this, screw dislocation defects, basal plane defects, and other dislocation defect are crystal defects unique to a silicon carbide substrate, but are not defects critical to device production. Even if a device is formed at a location where there are a small number of dislocation defects present, the device will operate normally. On the other hand, if there are a large number of dislocation defects in one chip section, this is liable to degrade the device characteristics. Therefore, the present invention outputs defect distribution data which includes data showing the presence of any killer defects and the number of dislocation defects for each chip section.

A silicon carbide substrate is transparent to light in the visible region and infrared region of wavelength. Therefore, if using a scanning device performing area illumination so as to scan a silicon carbide substrate by an illumination beam of the visible region or infrared region of wavelength, the light which enters the inside of the substrate and is reflected at the back surface of the substrate will be focused by the object lens and strike the photodetecting means. If such reflected light strikes the photodetecting means, the detection sensitivity will end up greatly falling. Therefore, in the present invention, to eliminate the effect of light which is reflected from the back surface of a silicon carbide substrate, a light source device which generates an illumination beam of an ultraviolet region of wavelength is used. Light of an ultraviolet region of wavelength does not pass through silicon carbide, so no light is reflected from the back surface of the substrate and the problem of a drop in detection sensitivity is prevented. Further, as light of an ultraviolet region of wavelength, it is preferable to use ultraviolet light at the wavelength side shorter than 350 nm. Further, when using a confocal scanning device for inspection, the light incidence plane of the imaging device is restricted. Light reflected from the back surface of the silicon carbide substrate will not strike the imaging device by nature. Therefore, when using a confocal scanning device for inspection, it is possible to use an illumination beam which has a visible region or ultraviolet region of wavelength.

An inspection apparatus according to a third mode of the invention is comprised of a confocal scanning apparatus comprising an optical source for producing a line shaped illumination beam extending along a first direction or an illumination beam including a plurality of sub-illumination beams aligned with one direction, a stage for supporting the silicon carbide substrate to be inspected and being movable along the first direction and a second direction perpendicular to the first direction, an objective lens for projecting the illumination beam onto the epitaxial layer or the silicon carbide substrate arranged on the stage, means for changing a relative distance between the objective and the silicon carbide substrate along the optical axis, and a line sensor having a plurality of light receiving elements aligned with a direction corresponding to the first direction and for receiving reflected light by the surface of the silicon carbide substrate or the epitaxial layer;

a differential interference optical system selectively disposed on an optical path between the optical source and the objective lens and for converting the incident illumination beam into two sub-beams which interfere each other and for combining the sub-beams reflected by the surface of the silicon carbide substrate or the epitaxial layer to produce an interference beam; and

a processor comprising an image formation means for receiving the output signals from the line sensor to form a differential interference contrast image of the surface of the silicon carbide substrate or the epitaxial layer, and defect detection means for detecting the defect existing in or on the silicon carbide substrate or epitaxial layer based on the formed differential interference contrast image, and means for forming a surface contour image of the surface of the silicon carbide substrate or epitaxial using a plurality of confocal images which are captured while changing the relative distance along the optical axis between the objective and the substrate.

If using a confocal scanning device in which a differential interference optical device is mounted, in addition to differential interference contrast image of the surface of a silicon carbide substrate, a surface contour image of the substrate surface can also be captured. A differential interference contrast image is an image which displays changes of surface relief of the substrate surface as 2D luminance information. As opposed to this, a surface contour image is a 3D image of the substrate surface. Therefore, if using a confocal scanning device on which a differential interference optical device is mounted, 2D image information and 3D image information of the substrate surface or epitaxial layer surface are acquired, so it becomes possible to classify a detected defect much more precisely. For example, a micropipe defect is a defect of the form of a hollow hole and is captured on a differential interference contrast image as a spot-shaped low luminance image. Therefore, when a spot-shaped low luminance image is detected, if capturing the surface contour image, it is possible to easily judge if the defect image is an image resulting from a micropipe defect.

Furthermore, in a confocal scanning device, the light incidence plane of the photodetecting means is restricted, so undesired scattered light will not strike the photodetecting means by nature. Therefore, there is the advantage that even if using illumination light which will pass through an SiC substrate, no light reflected from the back surface of the substrate will strike the imaging device and therefore the range of selection of illumination light becomes broader.

An inspection apparatus according to a fourth mode of the invention is comprised of an optical apparatus comprising an optical source for producing an illumination beam, a stage for supporting the silicon carbide substrate and being movable along a first direction and a second direction perpendicular to the first direction, an objective lens for projecting the illumination beam onto the epitaxial layer formed on the silicon carbide substrate arranged on the stage, a differential interference optical system disposed on an optical path between the optical source and the objective lens and for converting the incident illumination beam into two sub-beams which interfere each other and for combining the sub-beams reflected by the surface of the epitaxial layer to produce an interference beam, and an imaging device for receiving the interference beam exiting the differential interference optical system; and

a processor comprising an image formation means for receiving the output signals from the imaging device to form a differential interference contrast image of the surface of the epitaxial layer, and defect detection means for detecting the defect existing in or on the epitaxial layer using the formed differential interference contrast image, wherein

at least one of the rotation angle of the stage or the shearing direction of the differential interference optical system is constructed adjustably, and wherein

the differential interference contrast image in which a step bunching image is optically attenuated or extinct is formed, when the shearing direction of the differential interference optical system is adjusted to be perpendicular to an orientation flat of the substrate or to be parallel to an extending direction of the step bunching formed in the epitaxial layer.

An inspection system which includes a differential interference optical device uses the change in surface height of the scanned substrate to detect a phase difference occurring between two sub beams and outputs this as luminance information. Therefore, when the surface height of the substrate is uniform along the direction connecting the two sub beams (shearing direction), no phase difference will be formed between the two sub beams and a luminance image similar to a luminance image of a normal location will be formed. On the other hand, when the step flow growth method is used to form an epitaxial layer, step bunching sometimes occurs. This step bunching unavoidably occurs when the step flow growth method is used to form an epitaxial layer. The frequency of occurrence is sometimes high. Therefore, when the frequency of occurrence of step bunching is high, it is preferable to detect step bunching separate from other defects.

“Step bunching” is a line-shaped step difference which extends in a direction which is perpendicular to a direction of an orientation flat which is formed on the silicon carbide substrate. Substantially all step bunching are formed in parallel. Further, the height of step bunching is a substantially uniform height along the extension direction. Therefore, if scanning while setting the shearing direction of the differential interference optical device so as to be parallel to the extension direction of the step bunching, no phase difference will occur between the two sub beams and a state where step bunching is optically attenuated or not detected will be formed. On the other hand, a micropipe defect is detected on the differential interference contrast image as a substantially spot-shaped low luminance image, while a basal plane defect, edge dislocation defect, and other dislocation defects are detected as contrast images comprised of high luminance image parts and low luminance image parts combined. Further, a carrot defect, comet defect, etc. are defects which have specific shapes and are detected on the differential interference contrast image as luminance images of specific shapes. Therefore, if setting the shearing direction of the differential interference optical device to be parallel to the extension direction of step bunching for scanning the epitaxial layer surface and scanning the epitaxial layer surface, a differential interference contrast image where images of step bunching are attenuated or eliminated is formed. Therefore, it becomes possible to select and detect only defects other than step bunching. As a result, it becomes possible to detect defects not influenced by the frequently occurring step bunching.

In a preferred embodiment of the inspection apparatus, the inspection apparatus comprises a first inspection mode in which the defects other than the step bunching are mainly detected and a second inspection mode in which the step bunching is mainly detected, and wherein in the first inspection mode the shearing direction of the differential interference optical system is adjusted to be perpendicular to the orientation flat of the substrate or to be parallel to the extending direction of the step bunching, and in the second inspection mode the shearing direction of the differential interference optical system is adjusted not to be perpendicular to the orientation flat of the substrate or not to be parallel to the extending direction of the step bunching.

Using a single detection mode, it is possible to detect the step bunching and another defects simultaneously. In a preferred embodiment, said defect detection means comprises a first detection means which detects the defects other than the step bunching and a second detection means which detect the step bunching, and wherein the first detection means comprise means for attenuating the brightness change along the direction parallel to the orientation flat of the substrate or perpendicular to the extending direction of the step bunching, and the second detection means comprise means for enhancing the brightness change along the direction parallel to the orientation flat of the substrate or perpendicular to the extending direction of the step bunching.

An image which is formed by step bunching is line-shaped low luminance image or high luminance image which extends in a direction which is perpendicular to an orientation flat. Therefore, if performing image processing in an electrical circuit to attenuate changes in luminance in a direction parallel to the orientation flat, a differential interference contrast image where images of step bunching are attenuated or eliminated is formed. On the other hand, if performing image processing to enhance changes in luminance in a direction parallel to an orientation flat, a differential interference contrast image where images of step bunching are enhanced is formed. It therefore becomes possible to detect step bunching differentiated from other defects.

### Advantageous Effects of Invention

The inspection system according to the present invention captures a differential interference contrast image of a silicon carbide substrate or the surface of an epitaxial layer, so can capture fine defects of several nm to several tens of nm size which are formed on the substrate surface or the surface of the epitaxial layer as luminance images. Therefore, it can detect crystal defects unique to a silicon carbide substrate such as dislocation defects, shape defects, and other various types of defects. Furthermore, the differential interference contrast images of dislocation defects, micropipe defects, and shape defect differ in shape and luminance distribution for each defect, so it is possible to use a differential interference contrast image to classify a defect. Furthermore, the detected defect is classified in accordance with its category, so it is possible to divide a silicon carbide substrate into individual chip sections in which devices are scheduled to be formed and use the results of classification by the defect classifying means to output defect distribution data which shows the category and/or number of defects which is detected for each chip section.

### BRIEF DESCRIPTION OF DRAWINGS

FIG. 1 is a view showing one example of an optical system according to the present invention.

FIG. 2 is a view showing one example of a processor according to the present invention.

FIG. 3 is a view showing a defect classification method according to the present invention.

FIG. 4 is a view showing one example of a defect distribution data output apparatus.

FIG. 5 is a view showing one example of map information.

FIG. 6 is a view showing a modification of a processor according to the present invention.

FIGS. 7A to 7C give views showing examples of differential interference contrast images of an epitaxial layer.

FIG. 8 is a view showing a modification of a processor.

FIG. 9 is a view showing a modification of an optical system according to the present invention.

FIG. 10 is a view showing another modification of an optical system according to the present invention.

### EMBODIMENTS OF INVENTION

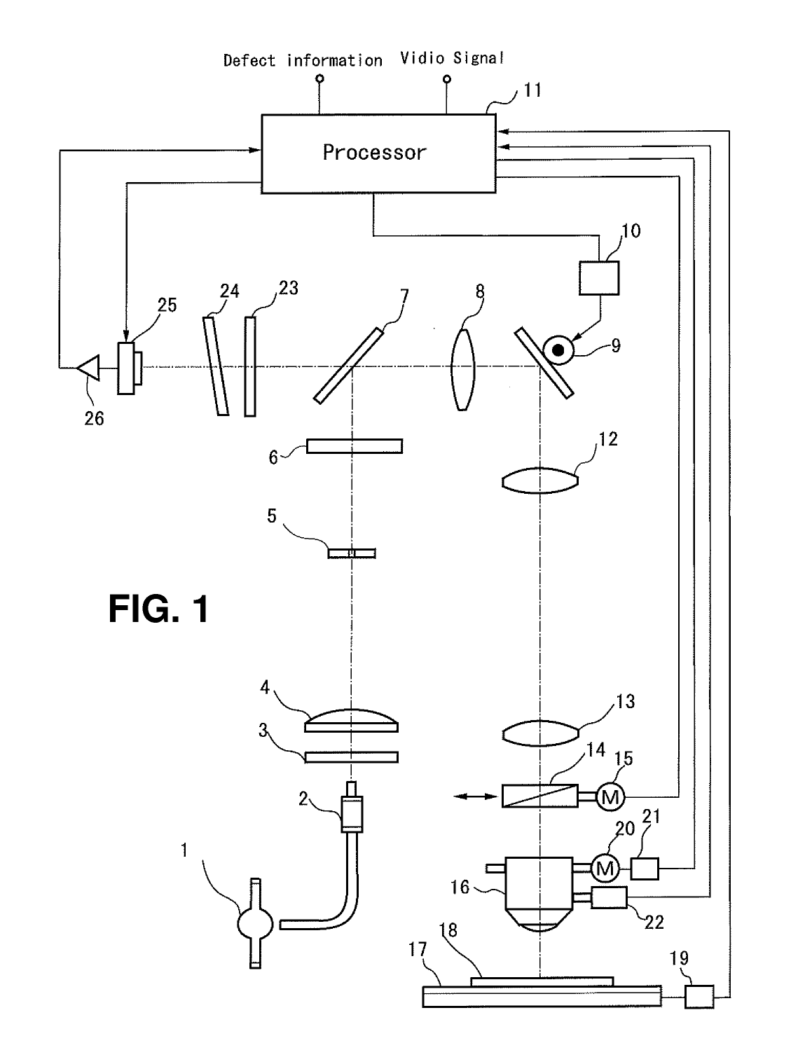

FIG. 1 is a line drawing showing one example of an optical system according to the present invention. In the present example, as the silicon carbide substrate to be inspected, a silicon carbide substrate (SiC substrate) on which an epitaxial layer is formed is used. Of course, it is also possible to inspect a silicon carbide substrate on which an epitaxial layer is not formed. Further, as an optical system, a confocal scanning device which has a differential interference optical device is used. The confocal scanning device is used to scan the entire surface of the silicon carbide substrate to capture a differential interference contrast image of the entire surface of the substrate. The obtained differential interference contrast image is processed by various image processing techniques to detect defects and their coordinates (addresses). Further, the address information of the detected defects can be used to review the differential interference contrast image of the defects and classify the detected defects. Furthermore, as a characteristic of a confocal scanning device, the Z-axial direction (optical axis direction) can be scanned, so the inspection system according to the present invention can not only capture a differential interference contrast image of the silicon carbide substrate, but can also capture a confocal image of the detected defects and acquire 3D shape information of the defects from the confocal image. Furthermore, it can acquire cross-sectional shape information (surface contour information) of the detected defects. Therefore, when judging the category of defects, it is possible to use the differential interference contrast image, 3D shapes, and cross-sectional shapes of the defects. Furthermore, it is possible to judge the category of defects by comparing the coordinates of the defects.

Referring to FIG. 1, as an illumination light source 1, a mercury lamp is used. Further, it is also possible to use a xenon lamp, laser light source, or other various illumination light sources other than a mercury lamp. The illumination beam emitted from the illumination light source 1 strikes an optical fiber bundle 2 comprised of a plurality of optical fibers bundled together, is propagated through the optical fibers, is emitted as a dispersive beam with a substantially circular cross-section, and strikes a filter 3. The filter 3 emits light of the green wavelength from the incident light beam (e-beam: wavelength 546 nm). The light beam which is emitted from the filter is converted to a parallel beam by a focusing lens 4 and strikes a slit 5. The slit 5 has a narrow opening which is arranged at a pupil position of the focusing lens 4 and extends in a first direction (direction perpendicular to paper surface). Here, the first direction is called the “X-direction”. The width of the opening of the slit 5 is, for example, set to 10 to 20 μm. Therefore, a narrow line-shaped illumination beam which extends from the slit 5 in the first direction is emitted. The line-shaped illumination beam which is emitted from the slit 5 strikes a polarizer 6 and is converted to polarized light which has a single vibrating plane. This polarized line-shaped illumination beam is reflected at a half mirror 7 which functions as a beam splitter, passes through a relay lens 8, and strikes a vibrating mirror 9.

A drive circuit 10 is connected to the vibrating mirror 9, and drives the vibrating mirror based on a control signal which is supplied from a processor 11. The vibrating mirror 9 deflects the incident line-shaped light beam to a second direction (Y-direction) perpendicular to the first direction. The processor 11 has Y-direction position information of the light beam based on the angle information of the vibrating mirror. Further, instead of a vibrating mirror, a polygon mirror or other scanning device can be used. Further, when using stage movement for scanning, the vibrating mirror is not necessarily required. The line-shaped illumination beam which is emitted from the vibrating mirror 9 passes through relay lenses 12 and 13 and enters a differential interference optical device 14. In the present example, a Normarski prism is used as the differential interference optical device. The line-shaped illumination beam which enters the Normarski prism 14 is converted to two sub beams with perpendicular vibrating planes. Between these two sub beams, a (2m+1)π/2 phase difference, where “m” is a natural number, is given. Therefore, a defect having a height of several nm which is formed on the SiC substrate surface can be detected as a luminance image.

The shearing amount of a Normarski prism is, for example, set to 2 μm. Further, a Normarski prism 14 is arranged to be able to be inserted into and retracted from the light path. It is inserted into the light path when capturing a confocal differential interference contrast image of the SiC substrate, and is removed from the light path when capturing a 3D image of a sample. The Normarski prism 14 has a motor 15 connected to it, so the shearing direction of the Normarski prism can be freely set. Therefore, the shearing direction of the Normarski prism 14 can be set to a direction perpendicular to the extension direction of the orientation flat which is formed on the silicon carbide substrate. In this case, the extension direction of the step bunching and the shearing direction of the Normarski prism become parallel to each other, so a differential interference contrast image in which the image of the step bunching is attenuated or eliminated is captured.

The two sub beams which are emitted from the Normarski prism 14 strike an object lens 16. The object lens 16 focuses the incident two line-shaped sub beams and emits the result toward the epitaxial layer surface of a silicon carbide substrate 18 which is arranged on a stage 17. Therefore, the surface of an epitaxial layer which is formed on the SiC substrate 18 is scanned in a perpendicular second direction (Y-direction) by the two line-shaped sub beams extending in the first direction (X-direction).

The stage 17 is comprised of an XY stage which can move in the X-direction and Y-direction. The position information of the stage is detected by a position sensor 19, then the position information of the stage is supplied to the processor 11. When scanning the entire surface of the SiC substrate 18 to detect defects, it is possible to hold the vibrating mirror 9 in a stationary state, make the stage 17 zigzag in the Y-direction and X-direction, and scan the entire surface of the SiC substrate. Alternatively, it is possible to make the stage 17 move continuously in the first direction and combine this with a scan of the second direction by the vibrating mirror 9 so as to inspect the entire surface of the SiC substrate for defects. Further, when using the addresses of the detected defects for review, it is possible to capture a differential interference contrast image of defects and their vicinity by using the coordinate information of the defects as the basis to make the stage move in the X- and Y-directions to position the defects in the field and making the vibrating mirror scan the second direction.

The object lens 16, to which a motor 20 and a motor drive circuit 21 are connected, can move along the optical axis direction by a drive control signal which is supplied from the processor 11. The position of the object lens in the optical axis direction is detected by a position sensor 22 and supplied to the processor 11. Here, the motor 20 functions as a means for changing the relative distance in the optical axis direction between the object lens and the SiC substrate on the stage, that is, the relative distance between the focal point of the light beam which scans the substrate surface and the substrate surface. Further, the object lens can move along the optical axis direction by a resolution of 10 nm.

Due to the characteristics of the confocal scanning device, it is possible to make the object lens 16 move along the optical axis direction while driving the vibrating mirror 9 to capture a 2D confocal image of the surface of the SiC substrate several times and to detect the position in the optical axis direction generating the maximum luminance value for each pixel so as to acquire a 3D image of the SiC substrate surface. Further, based on the acquired 3D image, it is possible to acquire a cross-sectional image showing the SiC substrate surface as a cross-section. Therefore, a hollow hole defect such as a micropipe defect which is formed in the epitaxial layer can be detected while differentiated from other defects by acquiring surface contour shape information including a 3D image or cross-sectional shape image. Further, when capturing a confocal image, the Normarski prism 14 is retracted from the light path for capturing the image.

Two reflected beams which are reflected at the surface of the SiC substrate are focused by the object lens 16 and enter the differential interference optical device 14. The two reflected sub beams are combined by the differential interference optical device 14, whereupon an interference beam which includes height changes of the SiC substrate surface as phase difference information is formed. For example, if there is a recessed or projecting defect of several nm size at the surface of the SiC substrate, one of the sub beams of the two sub beams which strike the SiC substrate surface will scan the defect, while the other sub beam will scan the normal surface part, so a phase difference corresponding to the height of the defect is introduced between the two sub beams. As a result, the interference beam which is emitted from the differential interference optical device 14 includes changes in surface relief of several nm size, which appear at the surface of the SiC substrate due to defects, as phase difference information.

The interference beam which is emitted from a Normarski prism 14 is propagated through the original light path in the opposite direction, passes through relay lenses 13 and 12 to strike a vibrating mirror 9, and is descanned by the vibrating mirror. The interference beam which is emitted from the vibrating mirror 9 passes through a lens 8 which acts as an imaging lens, passes through a half mirror 7, and strikes an analyzer 23. The analyzer 23 is arranged in a perpendicular relationship with respect to the polarizer 6. Therefore, light other than the polarized light which is combined at the Normarski prism 14 is blocked and only light forming the differential interference contrast image passes through the analyzer 23.

The line-shaped interference beam which passes through the analyzer 23 passes through a positioner 24 and strikes a linear image sensor 25 which acts as an imaging device. The linear image sensor 25 has a plurality of light receiving diodes which are arranged in a direction corresponding to the first direction and receives the incident line-shaped interference beam. The light receiving diodes of the linear image sensor convert the phase difference information which is included in the interference beam to luminance information. Therefore, surface relief shapes of several nm size which are formed on the surface of the SiC substrate or surface of the epitaxial layer are displayed as luminance images. The array of light receiving diodes which are arranged in a line shape in the linear image sensor are restricted in incidence aperture by a frame, so the result becomes substantially equal to that of an arrangement which pinholes are arranged at the front surfaces of the individual light receiving diodes. Therefore, by having reflected light from the SiC substrate surface be received by a linear image sensor, a confocal optical system which has a differential interference optical device is constructed.

The charges which are stored at the light receiving diodes of the linear image sensor are successively read by a read control signal which is supplied from the processor 11 and are output as a 1D image signal of the SiC substrate surface. The 1D image signal which is output from the linear image sensor is amplified by the amplifier 26 and supplied through a camera link to the processor 11. The processor 11 has an image processing board and uses the received 1D image signal, position information of the vibrating mirror, position information of the stage, etc. to generate a 2D image of the epitaxial layer surface or SiC substrate surface. Further, the generated 2D image is processed by filtering, binarization, threshold value comparison, and various other image processing to detect defects and acquire their coordinates.

An SiC substrate is transparent to the wavelength region of visible light. For this reason, there is the trouble that if scanning the surface of the SiC substrate by a light beam, the incident light beam passes through the inside of the SiC substrate, the light reflected at the back surface of the SiC substrate strikes the detector, and the resolution falls. For this reason, there is the problem that the both in the case of using a differential interference microscope to capture an image of the SiC substrate and in the case of using the laser scattering method to detect defects, the resolution is low and the precision of defect detection falls. As opposed to this, the confocal type of inspection system according to the present invention has a configuration substantially equivalent to one in which pinholes are arranged at the front surface of a linear image sensor, so light which passes through the SiC substrate and is reflected at the back surface deviates from the light path and does not strike the light receiving diodes of the linear image sensor. Only the reflected light which is reflected at the surface of the SiC substrate strikes the linear image sensor. As a result, by using the inspection system according to the present invention, it is possible to capture a confocal differential interference contrast image of a higher resolution than the differential interference contrast image which is obtained by a differential interference microscope and possible to detect defects by a much higher detection precision.

The optical system shown in FIG. 1 forms a confocal scanning device which has a differential interference optical device, so can capture a confocal differential interference contrast image of the SiC substrate surface. Furthermore, it is possible to form a 3D image of the SiC substrate surface and a cross-sectional shape which shows the contours of the SiC substrate surface as a cross-sectional image. That is, as a characteristic of a confocal optical system, when the focal point of the scanning beam is positioned at the sample surface, the reflected light of the maximum luminance will strike the linear image sensor. As the focal point of the scanning beam is displaced from the sample surface, the amount of the reflected beam which strikes the linear image sensor falls. Therefore, by making the object lens move along the optical axis direction, that is, by making the focal point of the line-shaped scanning beam move along the optical axis direction while using the vibrating mirror for scanning to capture a plurality of 2D confocal images and detecting the position in the optical axis direction of the object lens which generates the maximum luminance signal of the linear image sensor for each pixel, 3D shape information showing the contours of the SiC substrate surface is obtained. Further, from the obtained 3D shape information, it is also possible to obtain surface contour information which shows the surface contours, shown by cutting the SiC substrate at any plance, as a cross-section. Therefore, by capturing a 3D image of a detected defect, it is possible to display the shape of the defect in three dimensions and possible to obtain information advantageous for judgment of the category of the defect.

The differential interference optical device detects fine surface relief shapes of several nm size formed on the sample surface as phase differences. Therefore, when pits of several nm depth are formed in the SiC substrate surface due to edge dislocation defects, basal plane dislocations, and other dislocation defects present on the substrate, it is possible to detect images of the pits as luminance images. Furthermore, in relation to projecting defects and recessed defects, on the differential interference contrast image, upward slanting surfaces and downward slanting surfaces are captured as low luminance images or high luminance images, so it is possible to use the contrast luminance distribution which is shown in the captured differential interference contrast image as the basis to judge if a defect is a recessed defect or is a projecting defect. Therefore, it is possible to use a captured contrast differential interference contrast image as the basis to easily judge if a defect is a pit defect or a bump defect.

Furthermore, “step bunching” is a line-shaped step defect of a height of several nm to several tens of nm which extends in a direction perpendicular to the orientation flat. Therefore, by capturing a confocal differential interference contrast image of the epitaxial layer surface, it is detected as a low luminance or high luminance line-shaped luminance image. Further, when an epitaxial layer is formed with both lattice defects and step bunching, in the confocal differential interference contrast image, spot-shaped or specifically shaped luminance images and line-shaped luminance images are detected in a state mixed together.

Next, what kind of image a defect present on the SiC substrate and epitaxial layer is captured as in a differential interference contrast image which is captured by the inspection system according to the present invention will be explained.

### Shape Defects

A triangle defect, carrot defect, comet defect, half moon defect, or other such shape defect is a large sized recessed defect and is a defect having a triangular shape, carrot shape, or other specific shape. Therefore, as the differential interference contrast image, a low luminance image which has a specific shape is captured.

### Micropipe Defects

A “micropipe” is a defect of the form of a hollow hole. Therefore, when a scanning beam scans over a micropipe defect, the light which is reflected from the bottom of the hole does not strike the linear image sensor or only a very small amount of the reflected light strikes it, so this is captured as a spot-shaped low luminance image.

### Edge Dislocation Defects

An edge dislocation defect appears as a pit structure on the surface of an SiC substrate or an epitaxial layer. Therefore, it has a type of structure which has two downward and upward slanted surfaces and, in a differential interference contrast image, is captured as a contrast luminance image comprised of a low luminance image part and high luminance image part combined.

### Spiral Dislocation Defects

A screw dislocation, in the same way as an edge dislocation defect, appears as a pit structure on the surface of an SiC substrate and an epitaxial layer and is captured as a contrast luminance image comprised of a low luminance image part and high luminance image part combined.

### Basal Plane Defects

A basal plane defect appears as a pit structure at the surface of an SiC substrate and the surface of an epitaxial layer. Therefore, it is captured as a contrast luminance image in the differential interference contrast image.

### Bumps

A bump is a projecting type defect. It has an upward slanting surface and a downward slanting surface, so is detected as a contrast luminance image. However, the direction of occurrence of the high luminance image part and low luminance image part is reverse to that of a pit defect (dislocation defect). Accordingly, the difference in order of formation of the high luminance image part and the low luminance image part can be used to differentiate this from a dislocation defect.

### Step Bunching

When forming an epitaxial layer by the step flow growth method, sometimes “step bunching” occurs. This step bunching is a step defect which extends in a direction perpendicular to an orientation flat which is provided at a silicon carbide substrate. The differential interference contrast image of step bunching is captured as a line-shaped low luminance image which extends in a direction perpendicular to the orientation flat of a substrate. Therefore, a line-shaped low luminance image which extends in a direction perpendicular to the orientation flat of a substrate is classified as step bunching.

### Deposition of Foreign Matter

When foreign matter deposits on the surface, any metal or other foreign matter with a high reflectance which is deposited is detected as a spot-shaped high luminance image, while any foreign matter with a low reflectance which is deposited is captured as a spot-shaped dark low luminance image.

### Scratches

During polishing of a substrate, sometimes a scratch is formed. This scratch is a linear recessed structure, so is detected as a line-shaped contrast luminance image on the differential interference contrast image.

Next, the defect inspection method will be explained. As a characteristic of an SiC substrate, if there is a dislocation defect on the SiC substrate, when an epitaxial layer is subsequently formed, the dislocation defect which is present on the surface of the SiC substrate is propagated to the epitaxial layer. For example, if a basal plane dislocation is formed at the SiC substrate before the epitaxial layer is formed, if an epitaxial layer is formed at that SiC substrate, that basal plane dislocation becomes an edge dislocation defect or becomes a basal plane dislocation defect at the epitaxial layer. Further, a carrot defect or half moon defect or other defect having a specific shape which is formed on an epitaxial layer is often formed due to screw dislocation of the SiC substrate. Considering these characteristics of an SiC substrate, the following two techniques can be used as the defect inspection method according to the present invention. The first inspection method scans the entire surface of the SiC substrate before formation of the epitaxial layer, acquires a differential interference contrast image covering the entire surface of the SiC substrate surface, and detects defects and their coordinates from the differential interference contrast image. After this, the SiC substrate is formed with an epitaxial layer. Further, it scans the entire surface of the epitaxial layer after the epitaxial layer is formed and captures a differential interference contrast image of the entire surface of the epitaxial layer. Further, it detects defects in the SiC substrate after the epitaxial layer is formed. With this method, differential interference contrast images before and after formation of the epitaxial layer are obtained, so it is possible to compare defect images before and after formation of the epitaxial layer. Further, defects which are formed during the growth of the epitaxial layer can also be detected.

The second inspection method uses the inspection system according to the present invention shown in FIG. 1 so as to capture a confocal differential interference contrast image for the entire surface of the SiC substrate surface before the epitaxial layer is formed and processes the obtained confocal differential interference contrast image to obtain the defects and their addresses (coordinate information). Next, the inspected SiC substrate is formed with the epitaxial layer. After this, the SiC substrate on which the epitaxial layer is formed is again loaded in the inspection system, whereupon the location of the surface of the epitaxial layer designated by a defect address which was detected by the previous defect inspection is positioned in the field of the inspection system and a differential interference contrast image of the epitaxial layer surface is captured. Further, the defects are classified from the viewpoint of the shapes, sizes, and luminance distributions of the defects from the differential interference contrast image of the defects of the epitaxial layer surface. According to this inspection method, there is the advantage that the confocal differential interference contrast image is not captured for the entire surface of the substrate after formation of the epitaxial layer. It is captured only for part of the substrate. Therefore, the inspection time can be shortened.

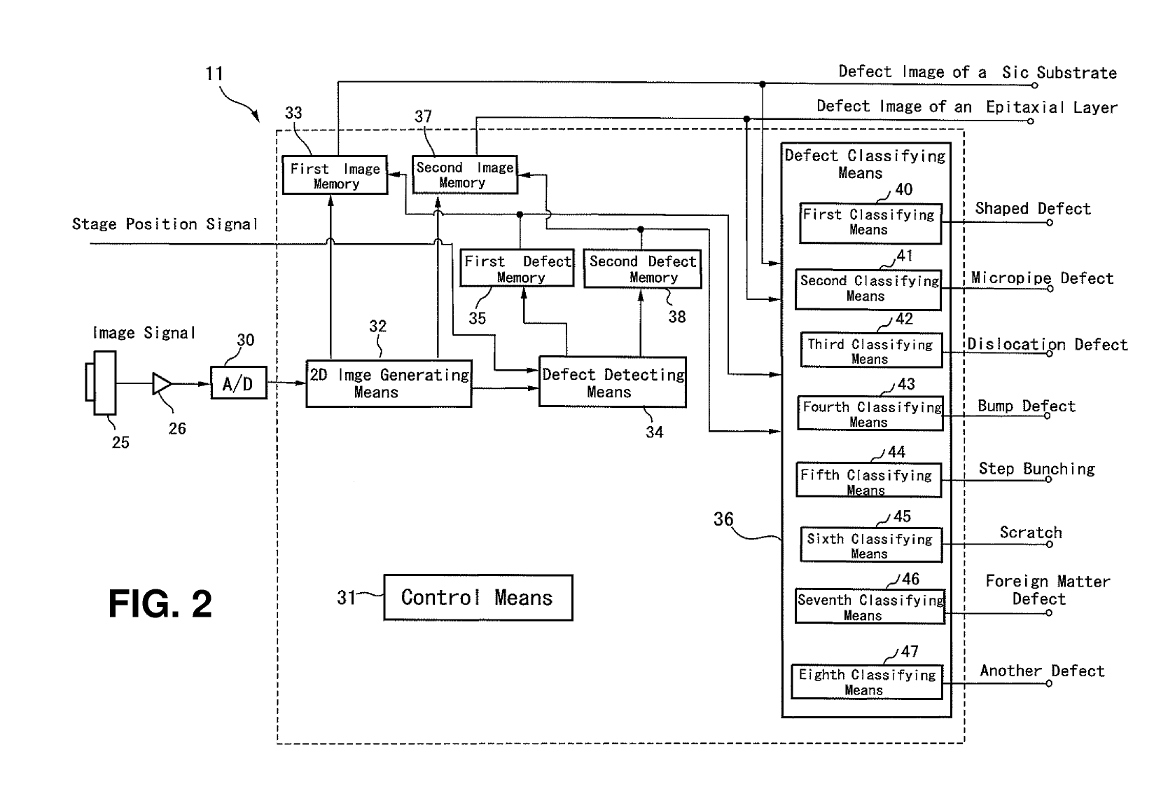

FIG. 2 is a line drawing showing an example of a processor 11 which performs defect detection and defect classification. The present example scans the entire surface of the SiC substrate before formation of the epitaxial layer to detect defects, detects defects for the entire surface of the SiC substrate after formation of the epitaxial layer, and classifies the defects based on these results. Of course, it is also possible to inspect the silicon carbide substrate before the formation of the epitaxial layer to detect defects and classify the detected defects or possible to inspect the silicon carbide substrate after formation of the epitaxial layer to detect defects and classify the detected defects.

The 1D image signal which is output from the linear image sensor 25 and amplified by the amplifier 26 is converted to a digital signal by the A/D converter 30 and supplied to the processor 11. Further, a stage position signal (digital signal) which shows the position of the stage 17 which supports the substrate is also supplied to the processor 11. Furthermore, an object lens position signal (digital signal) which is output from a position sensor 22 which shows the position of the object lens in the optical axis direction is supplied to the processor 11. In the present example, the processor 11 is comprised of software which is run by a computer. The various means operate under the control of the control means 31. Further, the signal lines from the control means 31 intersect in the figure, so are not shown.

The 1D image signal which is input to the processor 11 is sent to a 2D image generating means 32 where a 2D image, that is, a 2D differential interference contrast image, is formed. The 2D image signal is supplied to the first image memory 33. The differential interference contrast image of the SiC substrate surface before the formation of the epitaxial layer is stored in the first image memory 33. The 2D image signal which is formed by the 2D image generating means 32 is supplied to the defect detecting means 34. The defect detecting means 34 is also supplied with the stage position signal and the position information of the light receiving diodes of the linear image sensor. The defect detecting means 34 includes a filtering means, binarizing means, and threshold comparing means and processes an input 2D image to detect a defect. Simultaneously, it uses the stage position signal and the position information of the light receiving diodes of the linear image sensor to detect the coordinates (address information) of a detected defect. Further, when a defect is detected, an identification number of the detected defect and its coordinate information are stored as a pair in a first defect memory 35.

When examining a defect which is formed on the SiC substrate, it is possible to examine the differential interference contrast image of the defect for which review is desired under the control of the control means 31. In this case, the control means performs the following processing. That is, it accesses the first defect memory 35 and obtains the defect address specified by the defect identification number which was input through a keyboard. After this, it can access the first image memory 33, take out a predetermined size of an image of the acquired address, output this as a defect image of the SiC substrate, and display this on a monitor. Further, when classifying a defect of a SiC substrate, under the control of the control means 31, it is possible to use coordinate information of the defect which are stored in the defect memory so as to take out the defect image from the first image memory and supply this defect image to the defect classifying means 36. Further, a defect classifying means 36 judges the category of the defect.

After the SiC substrate finishes being inspected for defects, the SiC substrate is sent to the epitaxial layer growing apparatus where an epitaxial layer (monocrystalline layer) is formed on the SiC substrate.

The substrate on which the epitaxial layer is formed is again loaded in the inspection system which performed the defect inspection where the above defect inspection is performed and the epitaxial layer surface is inspected for defects and defect coordinates are acquired. That is, the 2D image generating means 32 is used to generate a 2D differential interference contrast image of the epitaxial layer surface, whereupon the generated 2D image is stored in the second image memory 37. Further, the generated differential interference contrast image is sent to a defect detecting means 34, defects which are formed on the epitaxial layer surface are detected, and coordinates of the detected defects are stored together with the identification numbers in the second defect memory 38. Therefore, the second defect memory 38 stores identification numbers of defects and their addresses paired together.

In parallel with the inspection of the epitaxial layer for defects or after inspection of it for defects, the detected defects are classified. When classifying a defect, the image memory 37 is accessed, a predetermined size of an image at a position which is designated by the address information of the defect is supplied to the defect classifying means 36 together with the identification number and defect address, and the differential interference contrast image of the defect is used as the basis for defect classification.

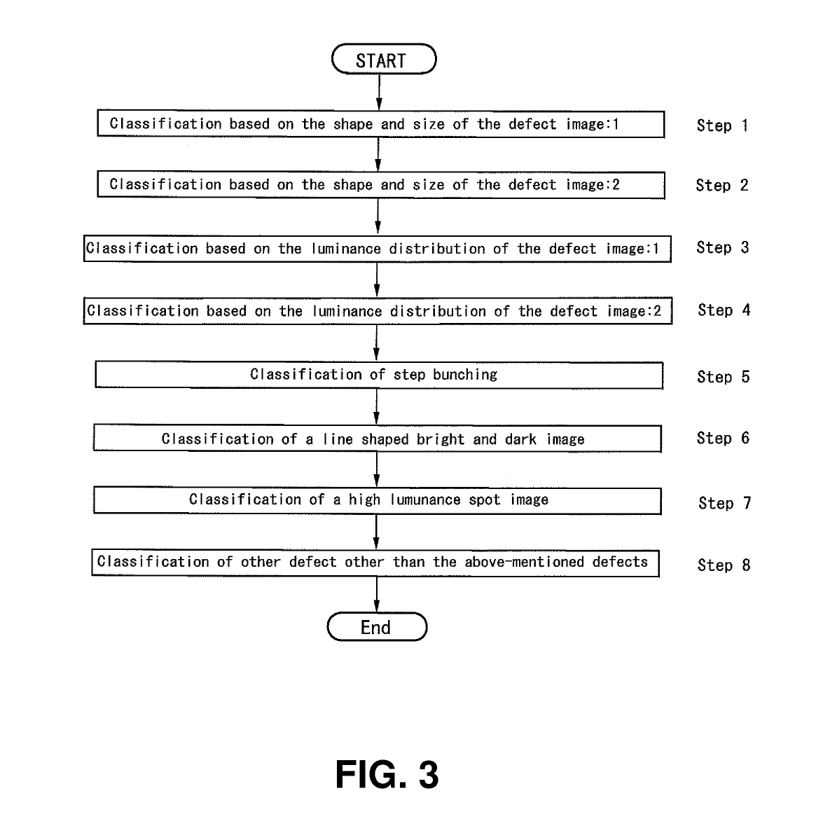

FIG. 3 is a view showing an example of a defect classification method according to the present invention. At step 1, defect classification 1 is performed based on the shape and size of the defect image. As defects which are formed at the epitaxial layer, carrot defects, triangle defects, comet defects, half moon defects, and other defects having specific shapes are killer defects critical to device production. When these killer defects are captured in a differential interference contrast image, they are detected as low luminance images of a relatively large size having specific shapes and are clearly differentiated from other defects. Therefore, in the present example, first, based on the shapes and sizes of the defect images, low luminance images of large sizes which have specific shapes are identified and classified as shape defects. Further, the classified shape defects are classified based on the shapes of the luminance images into carrot defects, triangle defects, comet defects, etc. (step 1).

After this, defect images which could not be identified at step 1 are processed by defect classification 2 based on the shapes and sizes of the defect images (step 2). In this classification step, micropipe defects are classified. A differential interference contrast image resulting from a micropipe defect is captured as a spot-shaped low luminance image, so a defect image which is detected as a spot-shaped low luminance image is classified as a micropipe defect.

After this, defect images which could not be classified at steps 1 and 2 are classified based on the luminance distributions of the defect images (step 3). Threading screw dislocation defects, basal plane defects, edge dislocation defects, and other dislocation defects are defects which do not correspond to killer defects critical to device production. These dislocation defects appear as pits in the epitaxial layer surface. Pits have downward slanting surfaces and upward slanting surfaces along the scan direction of the illumination beam, so are captured as contrast images of high luminance image parts and low luminance image parts combined. Therefore, defect images having contrast luminance distributions are classified as dislocation defects.

After this, projecting defects, that is, bump defects, are classified (step 4). Bump defects are also detected as contrast luminance distribution images, but the directions of occurrence of the high luminance image parts and low luminance image parts are opposite to those of pits in the scan direction. Accordingly, contrast images of directions of occurrence of high luminance image parts and low luminance image parts can be classified as bump defects.

After this, defect images which could not be identified at steps 1 to 4 are processed for detection of step bunching (step 5). Step bunching is captured as a line-shaped low luminance image which extends in a direction which is perpendicular to the orientation flat which is formed at the substrate. Therefore, a line-shaped low luminance image which extends in a direction which is perpendicular to the orientation flat is classified as step bunching.

Defect images which could not be identified at steps 1 to 5 are processed for detection of defects due to scratches (step 6). A scratch is a defect which occurs in the polishing process and is a line-shaped recessed defect. Therefore, a line-shaped contrast image is classified as a scratch.

Defect images which could not be identified at steps 1 to 6 are processed for detection of defects due to deposition of foreign matter (step 7). A defect image which is due to deposition of foreign matter such as deposition of high reflectance metal or other foreign matter is captured as a high luminance spot-shaped image. Therefore, a high luminance spot-shaped image is classified as a defect due to deposition of foreign matter (step 7).

Defect images which could not be identified at steps 1 to 7 are classified as other defects other than the above-mentioned seven types of defects (step 8).

Further, the above-mentioned defect classification technique may also be applied for defect classification for the SiC substrate surface before the formation of the epitaxial layer. Further, a SiC substrate does not have carrot defects, triangle defects, comet defects, and other shape defects and step bunching, but micropipe defects, dislocation defects, scratches, and other defects are identified by the above-mentioned defect classification.

It is not necessary to perform classification for all of the above-mentioned seven defects. It is also possible to perform classification only for defects required for device production. For example, triangle defects, carrot defects, and shape defects are killer defects critical to device production. Therefore, it is also possible to identify just killer defects and process other defects as miscellaneous defects. Alternatively, dislocation defects do not pose a problem in device production when few in number, but when a large number of dislocation defects are formed, the reliability of the device is liable to be degraded. Therefore, at the defect classification step, it is also possible to perform processing to identify shape defects and dislocation defects and not identify other defects. That is, the types of the defects which are classified in the defect classification step can be suitably set based on the objective and technical concept of the inspection system.

Referring to FIG. 2, the content of the processing of the defect classifying means 36 of the inspection system according to the present invention will be explained. The defect classification is performed in parallel with the defect detection processing or after the defect detection processing ends. The defect classifying means 36 of this example, as one example, has first to eighth classifying means 40 to 47 and judges what kind of defect an input defect image formed is due to. First, the defect image is supplied to the first classifying means 40. The first classifying means 40 classifies the input image based on the shape and size. That is, the first classifying means 40 has shape information forming the criteria for a carrot defect, comet defect, and other specific images and judges if a received defect image is similar to a specific shape. Due to this shape judgment, a defect image which is of a relatively large size and has a specific shape is identified and classified as a triangle defect, carrot defect, comet defect, or other shape defect.

A defect image which could not be judged as a shape defect by the first classifying means 40 is supplied to a second classifying means 41. The second classifying means 41 judges whether the input defect image is a spot-shaped low luminance image of several μm to several tens of μm in size. When the result of judgment is that it corresponds to a spot-shaped low luminance image, that defect is judged to be a micropipe defect.

A defect image which could not be identified as a micropipe defect is supplied to a third classifying means 42. The third classifying means 42 identifies a dislocation defect. The third classifying means judges if the input defect image is a contrast image comprised of a high luminance image part and a low luminance image part combined and judges the direction of occurrence of the high luminance image part and the low luminance image part. When the result of the judgment is that the input defect image is a contrast image and the direction of occurrence of the contrast image parts is a predetermined direction, it is judged that the input defect image is a defect image due to a dislocation defect.

A defect image which could not be judged as being a dislocation defect is supplied to a fourth classifying means 43. The fourth classifying means identifies a bump defect. The fourth classifying means judges if the input defect image is a contrast image comprised of a high luminance image part and a low luminance image part combined and judges the direction of occurrence of the high luminance image part and the low luminance image part. When the result of the judgment is that the input defect image is a contrast image and the direction of occurrence of the contrast image parts is a predetermined direction, it is judged that the input defect image is a defect image due to a bump defect.

When not being able to be judged as a bump defect, the defect image is supplied to a fifth classifying means 44 where it is judged if it is a defect image due to step bunching. A defect image due to step bunching is a line-shaped low luminance image which extends in a direction which is perpendicular to an orientation flat which is formed at the substrate. Therefore, the fifth classifying means 44 identifies a defect image as a defect image due to step bunching when the input defect image is a low luminance image which extends in a direction which is perpendicular to the orientation flat.

When not being able to be identified by the fifth classifying means, the defect image is supplied to a sixth classifying means 45. The sixth classifying means identifies a defect image due to a scratch. A scratch is a line-shaped polishing scar and is a line-shaped recessed defect. Therefore, a defect image due to a scratch is captured as a line-shaped contrast image. The sixth classifying means 45 judges that a defect image is a defect due to a scratch when the input defect image is a line-shaped contrast image.

A defect image which could not be identified by the sixth classifying means is supplied to a seventh classifying means 46. The seventh classifying means identifies foreign matter deposition defects. When metal or other high reflectance foreign matter is deposited, it is captured as a spot-shaped high luminance image. Therefore, the seventh classifying means judges that a defect image is a defect due to deposition of foreign matter when the input defect image is a spot-shaped high luminance image.

A defect image which could not be identified by the first to seventh classifying means 40 to 46 is classified by an eighth classifying means as a defect image due to another defect.

It is not necessary to have all of the above classifying means 40 to 47. It is also possible to suitably provide them in accordance with the objective of the defect inspection. For example, it is also possible to have just means for classifying shape defects and means for classifying dislocation defects and have other defects processed as miscellaneous defects. Alternatively, it is possible to provide means for classifying micropipe defects in addition to shape defects and dislocation defects. Further, it is possible to provide classifying means for classifying only killer defects.

As results of the defect classification, the defect classifying means 36 outputs defect classification information. Defect classification information includes the identification number, category, and address of a defect which was detected for each defect. Further, the defect classification information is supplied to a later defect distribution data output apparatus.

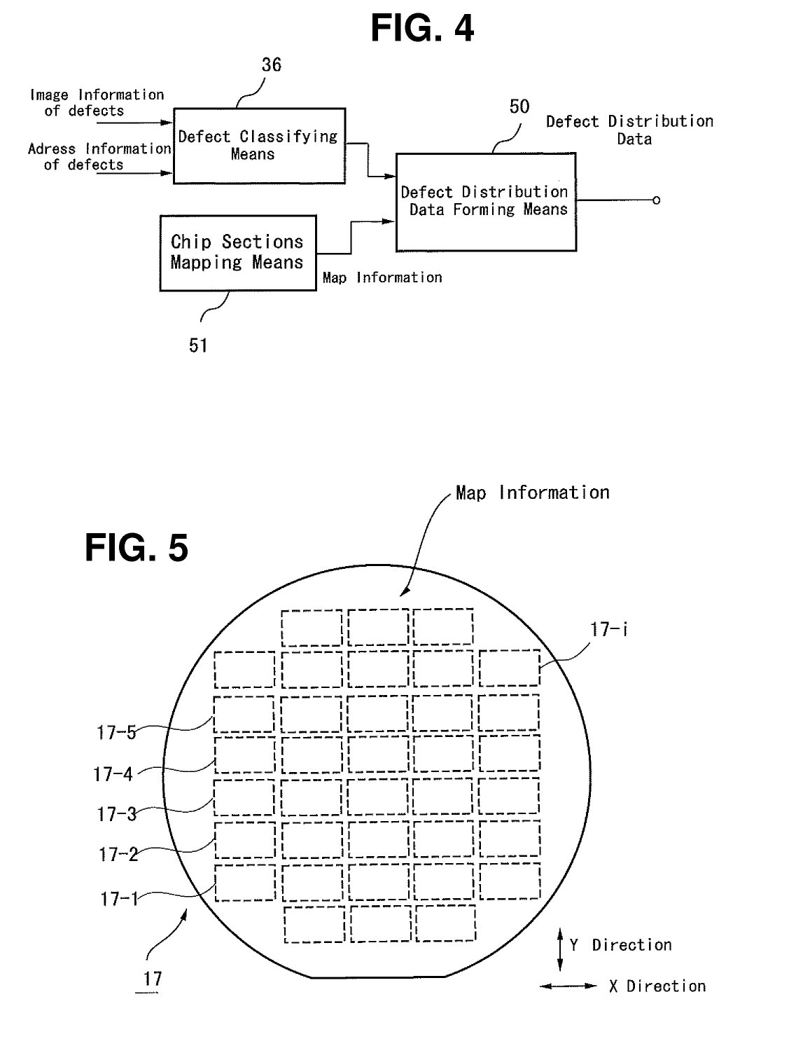

FIG. 4 is a view which shows a defect distribution data output apparatus which prepares defect distribution data which shows the state of distribution of the detected defects on a substrate. The inspection system according to the present invention uses a differential interference contrast image as the basis to detect defects, so can use defect images to classify the detected defects. Therefore, by using the categories of the defects and the address information of the defects detected, it is possible to obtain a grasp of the state of distribution of various types of defects on the silicon carbide substrate. That is, it is possible to use defect classification information which is output from the defect classifying means 36 to output the state of distribution of defects on the SiC substrate which is inspected or epitaxial layer which is formed on the SiC substrate. The defect classification information which is output from the defect classifying means 36 is supplied to a defect distribution data forming means 50. A mapping means 51 is connected to the distribution data forming means 50. This mapping means 51 forms map information which maps the plurality of chip sections 17-i on which devices are scheduled to be formed and supplies this map information to the defect distribution data forming means 50. FIG. 5 is a line drawing of one example of map information in which a plurality of chip sections 17-i at which devices are scheduled to be formed are mapped on the silicon carbide substrate 17.

The defect classification information includes an identification number of each defect and its category and its coordinate information. Further, the map information includes coordinate information and array information of the chip sections on which devices are scheduled to be formed. The defect distribution data forming means 50 uses the defect classification information and the map information to prepare information displaying the types and numbers of the defects included in the chip sections 17-i for each chip section and outputs this as defect distribution data. Further, the content of the defect distribution data can be set in accordance with the objective etc. of the defect inspection. For example, it is possible to obtain information which displays only the categories of detected defects or to obtain information which displays the categories of the detected defects and their numbers.

The defect distribution data can include information on killer defects. For example, triangle defects, carrot defects, and other shape defects are killer defects. If a device is formed at such a chip section, an inoperable device is liable to be formed. Therefore, the defect distribution data forming means 50 can provide a display indicating the presence of killer defects for chip sections in which shape defects or other killer defects are present. Further, dislocation defects and step bunching are not killer defects, but if the frequency of occurrence (number) becomes great, the reliability of the device which is formed is liable to fall. Therefore, the number of dislocation defects is displayed for each chip section. Further, based on the defect distribution data, it is possible to judge chip sections which include killer defects and chip sections which have more than a predetermined number of dislocation defects as “poor chip sections” and exclude devices which were formed at the poor chip sections. If such defect distribution data is output, chip sections giving inferior products can be identified, so quality control data advantageous for improvement of the yield in device production can be obtained. Further, the types of defects included among the killer defects can be determined in accordance with the objective of the defect inspection etc. For example, it is possible to define only shape defects as killer defects or possible to define shape defects and micropipe defects as killer defects.

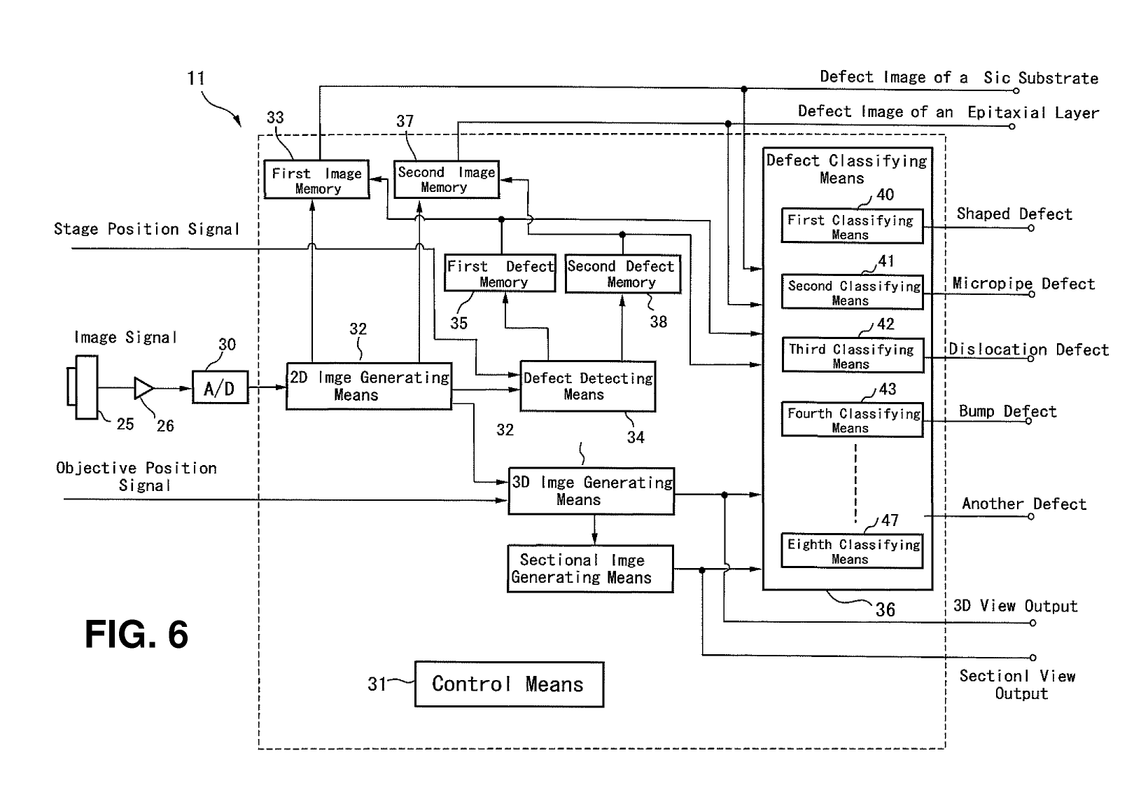

Next, the method of formation of the 3D image and cross-sectional shape image of the epitaxial layer surface or SiC substrate surface will be explained. FIG. 6 shows one example of a processor which has an image processing means for forming a 3D image of the epitaxial layer surface. Further, component elements the same as the component elements which were used in FIG. 2 are assigned the same reference notations and explanations therefore are omitted. The 2D image which is formed by the 2D image generating means 32 and the position of the object lens in the optical axis direction are supplied to the 3D image forming means 50. The 3D image forming means 50 moves the object lens in the optical axis direction while detecting the position in the optical axis direction giving the maximum luminance value for each pixel of the plurality of 2D confocal images captured and obtaining 3D image information which shows a 3D image of the SiC substrate surface. The obtained 3D image information is supplied to the defect classifying means 36 and used for defect classification. Further, it can be output as 3D image output and used for displaying a 3D image of defects on a monitor.

The 3D image information which is obtained by the 3D image forming means 50 is supplied to the cross-section image forming means 51 as well. The cross-section image forming means 51 uses the 3D shape information as the basis to generate cross-sectional image information which shows a 2D contour shape showing the epitaxial layer surface along a designated line sliced at a specific plane, that is, a contour shape of the surface of the SiC substrate, as a cross-sectional image. The obtained cross-sectional shape information is supplied to the defect classifying means 36 and is used for detection of micropipe defects etc. Further, it is also possible to output a cross-sectional shape as image output, display this on a monitor, and display on the monitor a cross-sectional shape showing a location including a micropipe defect cut at a plane perpendicular to the substrate surface.

The defect classifying means 36 uses the differential interference contrast image, 3D image, and cross-sectional image of defects to classify the detected defects. For example, when the differential interference contrast image of a defect is a spot-shaped low luminance image, it becomes possible to use the 3D image to judge if the defect is a hollow hole. Furthermore, when the differential interference contrast image of the defect is a contrast image, it is possible to use the cross-sectional image to judge if the defect is a projecting defect or a recessed defect. Therefore, by using the differential interference contrast image plus the 3D image and cross-sectional image, much more accurate defect classification is possible.

Next, inspection for step bunching which is formed on the epitaxial layer will be explained. When forming an epitaxial layer on an SiC substrate by the step flow growth method, step bunching sometimes occurs. When the density of occurrence of step bunching is high, the number of step bunching which is detected together with crystal defects becomes too great and detection of crystal defects is liable to become troublesome. Therefore, it is necessary to set an inspection state in which defects are detected in a state where step bunching is not detected. On the other hand, the distribution density of step bunching differs according to the region or location of a substrate. There are locations in the epitaxial layer where no step bunching is formed at all, while there are locations where step bunching is formed in a high density. Therefore, if the distribution density of the step bunching could be detected for the epitaxial layer which is formed on the substrate, information advantageous to quality control of the SiC substrate could be obtained and information extremely useful for improving the yield in device production could be obtained.

Therefore, in the present example, two inspection modes are set and the two inspection modes can made able to be switched between. The first inspection mode is a mode which mainly detects shape defects, micropipe defects, dislocation defects, and other defects other than step bunching. The second inspection mode is a mode which detects step bunching differentiated from other defects and mainly detects step bunching. The first inspection mode considers the characteristics of step bunching and the characteristics of the differential interference optical device so as to form a state in which only step bunching is not optically detected, that is, an inspection state in which the detection sensitivity falls for only step bunching, and detects defects in that state. The second inspection mode detects both step bunching and other defects on the confocal differential interference contrast image and performs image processing tailored to the shape unique to step bunching, that is, the characteristic of being captured as a line-shaped low luminance image which extends in one direction, that is, image processing for enhancing a change in luminance in a direction perpendicular to the extension direction of step bunching, so as to detect step bunching differentiated from other defects.

The method of setting the two inspection modes will be explained next. As explained above, step bunching is a line-shaped step of a substantially uniform height. Most step bunching extends in a direction perpendicular to the direction of formation of the orientation flat of a substrate. Further, as a characteristic of a differential interference optical device, when there is no change in height of a sample surface along a shearing direction, no phase difference occurs between the two sub beams. Therefore, if scanning while setting the extension direction of step bunching, that is, the direction perpendicular to the extension direction of the orientation flat, to be parallel to the shearing direction of the differential interference optical device, no phase difference occurs between the two sub beams and an inspection state in which the detection sensitivity falls for only step bunching is formed. This inspection state can be set by adjusting the shearing direction of the differential interference optical device or the rotational angle of the stage which supports the substrate. For example, the rotational angle of the stage which supports the SiC substrate is adjusted to become perpendicular to the orientation flat which is formed at the SiC substrate. By performing inspection in this state, the two sub beams simultaneously scan step bunching, no phase difference occurs, and an inspection state in which the detection sensitivity falls for step bunching is formed.

On the other hand, in the second inspection mode which positively detects step bunching, the shearing direction of the differential interference optical device or the rotational angle of the stage is set so that step bunching is easily detected. For example, if adjusting the shearing direction of the differential interference optical device or the rotational angle of the stage so that the shearing direction of the differential interference optical device becomes perpendicular to the extension direction of the step bunching, it is possible to capture a clear image of step bunching. However, in the luminance image of step bunching, the more the extension direction of step bunching and the shearing direction deviate from the parallel state, the greater the difference in luminance from the surrounding image. If exceeding a certain angle, an image of a substantially constant luminance value is obtained. Therefore, it is preferable to perform inspection in a state where the shearing direction and the extension direction of step bunching perpendicularly intersect, but making them strictly perpendicular is not necessary. It is also possible to perform the second inspection mode by setting a state where the shearing direction and the extension direction of step bunching are off from the parallel state.

Here, the scanning technique in the first inspection mode will be explained. First, a substrate is placed on the stage. At this time, the orientation of the substrate with respect to the stage is defined by the orientation flat which is formed at the substrate. After this, the rotational angle of the stage about its optical axis is adjusted to set the shearing direction of the differential interference optical device and the extension direction of the orientation flat to perpendicularly intersect. Alternatively, the stage is fixed in state and the shearing direction of the differential interference optical device is adjusted to become perpendicular to the direction of the orientation flat. In this state, the differential interference contrast image starts to be captured. Further, the differential interference contrast image is captured for part of the substrate and it is checked if step bunching has been removed. If step bunching remains, the stage or differential interference optical device can be finely adjusted to set a state in which step bunching is substantially completely eliminated.

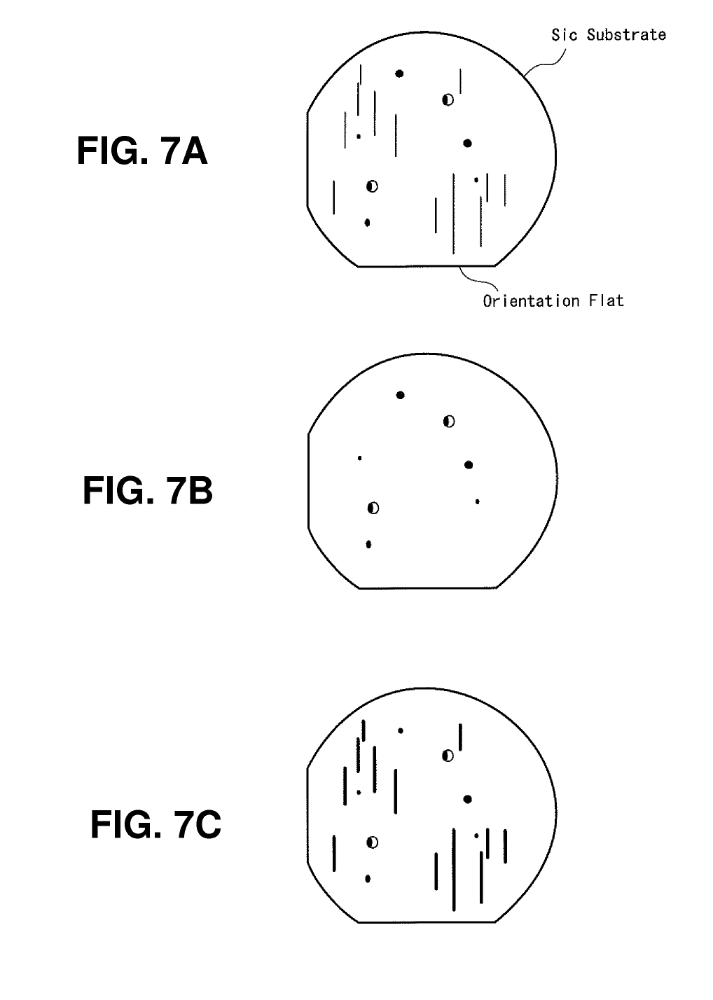

FIGS. 7A to 7C are views which schematically show confocal differential interference contrast images which are captured in the first and the second inspection mode. FIG. 7A schematically shows a differential interference contrast image of the epitaxial layer surface. Lattice defects and defects due to deposition of foreign matter are observed as spot-shaped luminance images, while step bunching are observed as line-shaped luminance images extending in a direction perpendicular to the orientation flat. FIG. 7B shows an image which is observed in the first inspection mode. In the first inspection mode, the detection sensitivity in the direction perpendicular to the orientation flat is reduced, so almost all images of step bunching are attenuated and only crystal defects and other defect images are captured. FIG. 7C shows an image obtained by image processing enhancing the step bunching. Since image processing is performed to enhance the changes in luminance in a direction perpendicular to step bunching, an image in which images of step bunching are enhanced is obtained.

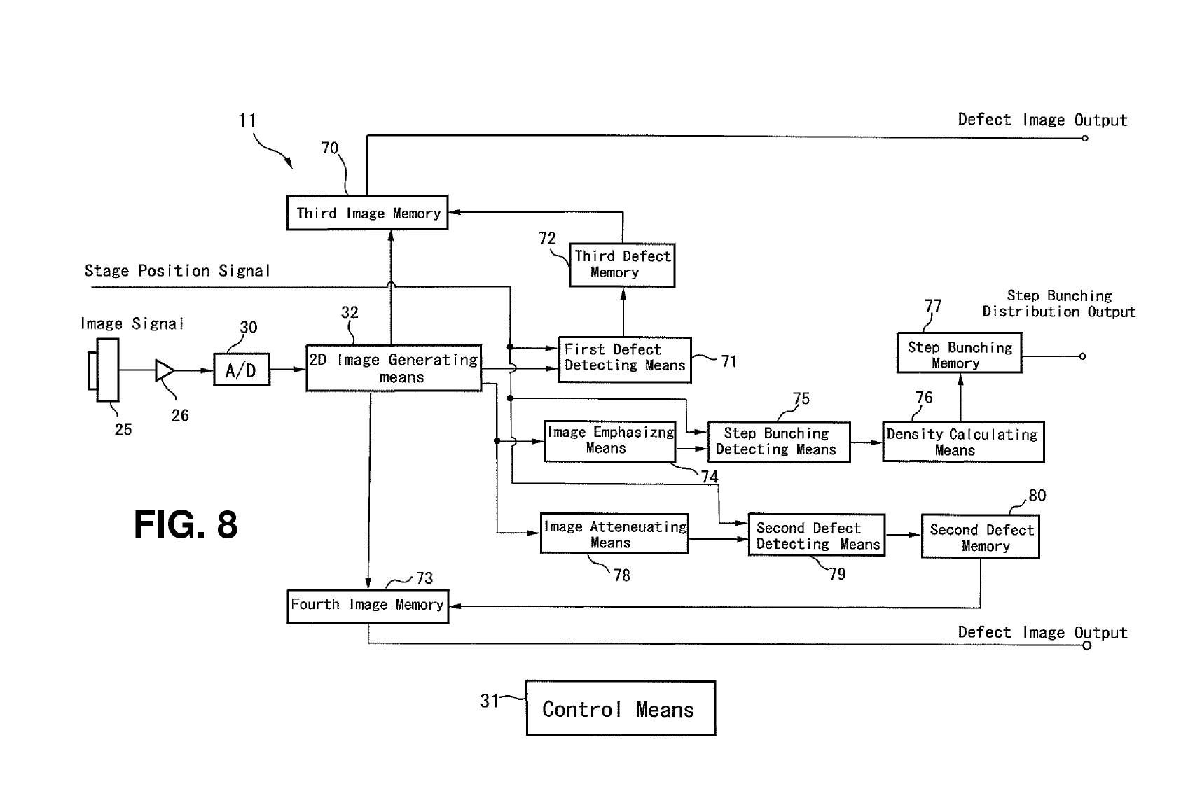

FIG. 8 is a line drawing showing one example of a processor 11 which performs detection of defects and detection of the distribution density of the step bunching. Component elements the same as component elements which were used in FIG. 2 are assigned the same reference notations and explanations thereof are omitted. In the first inspection mode, inspection is performed in an inspection state in which the detection sensitivity to step bunching is suppressed, so a differential interference contrast image in which images of step bunching are attenuated is captured. A 1D image signal which is input to the processor 11 is sent to the 2D image generating means 32 where a 2D image, that is, a differential interference contrast image, is formed. This image signal is supplied to a third image memory 70. The differential interference contrast image of the epitaxial layer is stored in the third image memory 70. The image which is stored in the third image memory 70 is an image in which step bunching is optically attenuated. The 2D image signal which is formed by the 2D image generating means 32 is supplied to the first defect detecting means 71. The first defect detecting means 71 is also supplied with a stage position signal and position information of the light receiving diodes of the linear image sensor. The first defect detecting means includes a filtering means, binarizing means, and threshold comparing means and performs image processing on the input differential interference contrast image to detect defects. Simultaneously, it uses the stage position signal and position information of the light receiving diodes of the linear image sensor to acquire the coordinates of the detected defects. The coordinates of the detected defects are stored in the third defect memory 72.

When observing a defect which is formed at the epitaxial layer, under the control of the control means 31, it is possible to use the defect coordinate information which is stored at the first defect memory 35 so as to access the third image memory 70, take out a predetermined size of an image including the designated defect, output this as an image of a defect which is present at the epitaxial layer, and display this on a monitor. Therefore, it is possible to display a lattice defect etc. other than step bunching on the monitor and examine the defect image. In this case, a monitor image is formed in which no step bunching is displayed, so a defect image which is useful for detailed analysis of the shape of the defect etc. is displayed. Further, when classifying a defect of the epitaxial layer, under the control of the control means 31, coordinate information of the defect which is stored at the defect memory is used to take out a defect image from the third image memory and the defect image is supplied to the defect classifying means. Further, in the defect classifying means, the category of the defect is judged and the category of defect is output.

Next, the second inspection mode, that is, the inspection mode for detecting the distribution density of step bunching, will be explained. In the second inspection mode, unlike the first inspection mode, the shearing direction of the differential interference optical device is set to a direction parallel to the orientation flat (direction perpendicular to extension direction of step bunching), the epitaxial layer surface is scanned, and a differential interference contrast image of the epitaxial layer surface is captured. The image signal which is output from the linear image sensor 23 is converted from an analog to digital format and supplied to the 2D image generating means 32. The 2D image information which is generated at the 2D image generating means 32 is supplied to the fourth image memory 73, whereby a confocal differential interference contrast image which includes all defect images including the step bunching is stored.

Further, the generated differential interference contrast image is supplied to an image enhancing means 74. This image enhancing means 74 performs processing for enhancing changes in luminance in a direction perpendicular to the extension direction of step bunching images on the differential interference contrast image. The image enhanced image signal is supplied to a step bunching detecting means 75. The step bunching detecting means 75 is also supplied with stage position information. The step bunching detecting means has an edge detecting means for detecting an edge of an image in a direction perpendicular to the extension direction of step bunching and a threshold comparing means and detects step bunching. The detected step bunching is supplied to a density calculating means 76 where the number (density) of step bunching per unit area is measured. The calculated density information of the step bunching is supplied to a step bunching memory 77. As the distribution density of the step bunching, as explained using FIG. 4 and FIG. 5, the SiC substrate is divided into a plurality of chip sections at which devices are scheduled to be formed and the number of step bunching which is formed at each chip section is calculated for each chip section. Further, the calculated step bunching distribution density information is supplied to the step bunching memory. As a result, the number of step bunching is displayed for each chip at which a device is scheduled to be made. Information advantageous for quality control is thereby obtained.

The calculated distribution density of the step bunching can be output to a monitor under the control of a control means 31. As the method of display on the monitor, the number of step bunching which is detected per unit area can be output as 255 levels of luminance information or the number of step bunching which is detected for each section can be directly displayed.

Next, an embodiment in which a single optical scan is used to individually and simultaneously detect in parallel both step bunching and defects other than step bunching will be explained. Step bunching is detected as line-shaped low luminance images on a differential interference contrast image. Further, substantially all step bunching extend in parallel to each other in a direction perpendicular to the orientation flat. Based on this characteristic distinctive to step bunching, in the present embodiment, two defect detecting means are used to individually and simultaneously perform in parallel the detection of step bunching and the detection of other defects.

The shearing direction of the differential interference optical device is set to be parallel to the direction of the orientation flat and the second inspection mode in which both step bunching and other defects are manifested is set. In this state, an optical scan is performed to capture a differential interference contrast image of the epitaxial layer surface. Referring to FIG. 8, the 2D image information which is output from the image generating means 32 is supplied to the third image memory 73. Further, it is supplied to the image enhancing means 74 whereby the above-mentioned image processing is performed to detect step bunching. The distribution density of the step bunching is therefore output.

The 2D image information which is output from the image generating means 32 is also supplied to an image attenuating means 78. This image attenuating means 78 performs filtering to attenuate changes in luminance in a direction perpendicular to the extension direction of step bunching and outputs an image from which step bunching has been removed. The image from which step bunching has been removed is supplied to a second defect detecting means 79 where binarization and threshold value comparison are performed to detect defects other than step bunching. Further, the second defect detecting means 79 is also supplied with stage position information and also detects coordinate information of the detected defects. The detected defect coordinates are supplied to a second defect memory 80. When reviewing the image of a detected defect, under the control of the control means 31, defect coordinate information which is stored in the second defect memory 80 can be used to access the third image memory 73, a predetermined size of an image including the designated defect can be taken out, and this can be output as a defect image of the epitaxial layer image and can be displayed on a monitor.

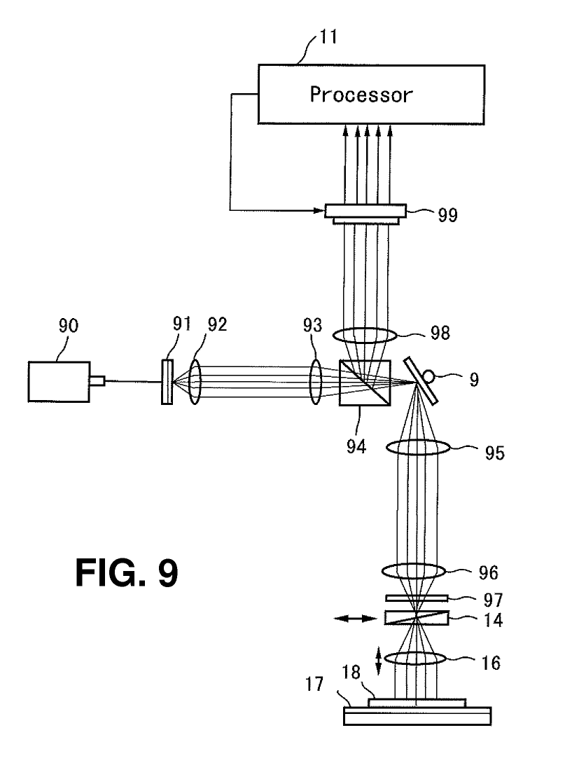

FIG. 9 is a view showing a modification of the optical system according to the present invention. In the present example, an optical system which uses a plurality of scanning beams arrayed along a first direction so as to scan the surface of an SiC substrate or an epitaxial layer will be explained. Further, component elements which are the same as the component elements which are used in FIG. 1 are explained while assigned the same reference notations. As the illumination light source, a laser light source 90 is used. The wavelength of the laser beam which is emitted from the laser light source can be made the infrared region, visible region, or ultraviolet region wavelength. The laser beam which is emitted from the laser light source 90 strikes a diffraction lattice 91 and is converted to a plurality of light beams (multi beam) arranged along the first direction. This multi beam passes through first and the second relay lenses 92 and 93 to strike a polarized beam splitter 94 and passes through the polarized beam splitter 94 to strike a vibrating mirror 9. The vibrating mirror 9 is used when reviewing a detected defect and is held in a stationary state when defect detection processing is performed. The vibrating mirror deflects the incident plurality of light beams along a second direction which is perpendicular to the first direction. The plurality of light beams which are reflected at the vibrating mirror 9 pass through the third and fourth relay lenses 95 and 96 and through a ¼ wavelength plate 97 to strike a Normarski prism 14. Each light beam which enters the Normarski prism 14 is converted to two sub beams with perpendicular vibrating planes. Between these two sub beams, a (2m+1)π/2 phase difference, where “m” is a natural number, is given.

The two sub beams which are emitted from the Normarski prism 14 strike an object lens 16. The object lens 16 focuses the incident sub beams and emits them toward an SiC substrate 18 to be inspected which is arranged on a stage 17. Therefore, the surface of the SiC substrate 18 is scanned by the two sub beams arranged along the first direction in a second direction which is perpendicular to the direction of arrangement of the light beams. Further, the stage 17 which supports the SiC substrate 18 is comprised of a stage which can move in the X- and Y-directions. When defect detection processing is performed, the entire surface of the SiC substrate 18 is scanned by the sub beams by movement of the stage. Further, when reviewing a detected defect, the stage 17 is held in the stationary state, the defect section is scanned by scanning of the vibrating mirror 9, and the defect image is displayed on a monitor. Further, the position of the stage 17 is detected by a position sensor (not shown) and supplied to a processor 11.

The sub beams which are reflected at the surface of the SiC substrate 18 are focused by the object lens 16 and strike the Normarski prism 14. At the Normarski prism, related reflected beams are combined, whereby a plurality of interference beams which include changes in height of the SiC substrate surface as phase differences are produced. These plurality of interference beams pass through a ¼ wavelength plate 97 and fourth and third relay lenses 96 and 95 and strike the vibrating mirror 9. Further, they are descanned by the vibrating mirror and strike a polarized beam splitter 94. The incident plurality of interference beams pass through the ¼ wavelength plate two times, so are reflected at the polarizing face of the polarized beam splitter, pass through a focusing lens 98, and strike a linear image sensor 25. The linear image sensor 25 is comprised of a 1D line sensor comprised of a plurality of photodiodes arranged in a line shape in a direction corresponding to the first direction. Further, the interference beams strike the corresponding photodiodes. The charges which are stored at the photodiodes are successively read out by a drive signal which is supplied from the processor 11 and are supplied to the processor 11 as a 1D image signal. In the processor, based on FIG. 2 and FIG. 3, defect detection and classification of the detected defects are performed.

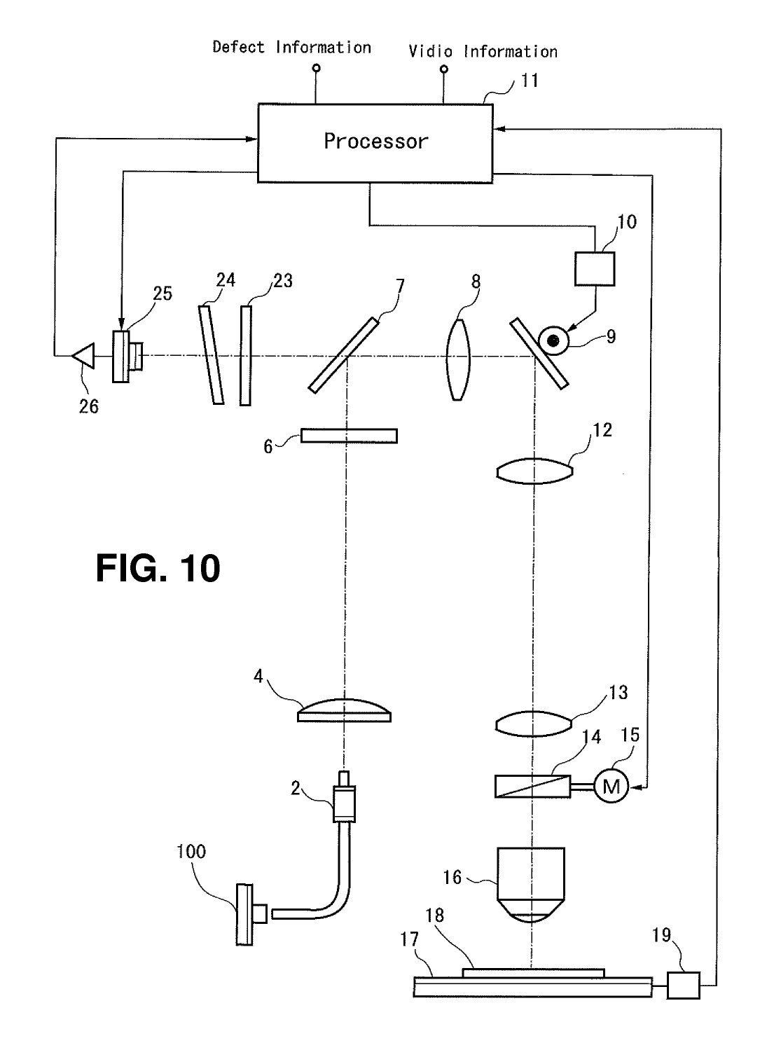

FIG. 10 shows another modification of the optical system according to the present invention. In the present embodiment, an illumination spot which has a relatively broad illumination area is used to scan the surface of the SiC substrate or epitaxial layer. Further, component elements the same as the members used in FIG. 1 will be explained assigned the same reference notations. In the present embodiment, as the light source device, a laser light source 100 which emits a UV region laser beam is used. An SiC substrate is transparent to visible region and infrared region wavelength light. Therefore, the problem arises that reflected light from the back surface of the substrate strikes the photodetecting means causing a drop in the sensitivity of defect detection. Therefore, in the present example, as the illumination light source, a laser light source which emits ultraviolet region wavelength illumination light is used. Light of an ultraviolet region of wavelength does not pass through an SiC substrate, so formation of undesirable reflected light from the back surface of the SiC substrate is prevented. Further, as ultraviolet region illumination light, it is preferable to use 350 nm or less wavelength light. The laser beam which is emitted from the laser light source 100 travels through the optical fibers 2 to strike the focusing lens 4 where it is converted to an enlarged parallel beam. This parallel beam passes through the polarizer 6 and is converted to a polarized beam with a substantially circular cross-section. The polarized beam is reflected at the half mirror 7 which functions as a beam splitter, passes through the relay lens 8, and strikes the vibrating mirror 9.

The light beam which is reflected at the vibrating mirror 9 passes through the relay lenses 12 and 13 and strikes the Normarski prism 14. Two sub beams are emitted from the Normarski prism 14 and strike the object lens 16. The object lens 16 emits the two sub beams toward the silicon carbide substrate 18 which is arranged on the stage 17. Therefore, the surface of the silicon carbide substrate 18 is formed with a circular illumination spot which has a relatively broad area.

The stage 17 is comprised of an XY stage which can move in the X-direction and the perpendicular Y-direction. By the stage 17 zigzagging in the X- and Y-directions, the surface of the SiC substrate is scanned two-dimensionally by a circular illumination beam. The reflected light from the surface of the SiC substrate or the epitaxial layer formed on it is focused by the object lens 16 and strikes the Normarski prism 14. The interference beam which is emitted from the Normarski prism passes through the relay lenses 13 and 12 and strikes the vibrating mirror 9. The interference beam which is emitted from the vibrating mirror 9 passes through the lens 8 which acts as a focusing lens, passes through the half mirror 7, and strikes the analyzer 23.

The interference beam which passes through the analyzer 23 passes through the positioner 24 and strikes the line sensor 25 which acts as an imaging device. The 1D image signal which is output from the line sensor 25 passes through the amplifier 26 and is supplied to the processor 11. In the processor 11, a differential interference contrast image is formed. Based on the formed differential interference contrast image, defect detection and defect classification are performed. Further, as an imaging device to take the place of a line sensor, a TDI sensor can also be used. When using a TDI sensor as an imaging device, the charge transfer speed of the TDI sensor is matched with the stage movement speed.

The present invention is not limited to the above-mentioned embodiments and can be modified and changed in various ways. For example, in the above-mentioned embodiments, an object lens was made to move along the optical axis direction so as to change the relative distance between the focal point of the scanning beam and the substrate surface, but it is also possible to fix the object lens in place and make the stage which supports the SiC substrate move along the optical axis direction so as to change the relative distance between the focal point of the scanning beam and the substrate surface.

Furthermore, in the above-mentioned embodiments, the explanation was given of a confocal scanning device constituted by a confocal scanning device which uses a line-shaped scanning beam and a confocal scanning device which uses a multibeam to scan the sample surface, but of course it is also possible to use a confocal scanning device which scans the substrate surface by a single scanning beam.

Furthermore, in the above-mentioned embodiments, a Normarski prism was used as the differential interference optical device, but it is also possible to use a Rochon prism, Wollaston prism, or other differential interference optical device.

What is we claimed is:

1. An inspection apparatus for detecting a defect existing in or on a silicon carbide substrate or an epitaxial layer formed on the silicon carbide substrate comprising:
an optical apparatus comprising an optical source for producing an illumination beam, a stage for supporting the silicon carbide substrate to be inspected and being movable along a first direction and a second direction perpendicular to the first direction, an objective lens for projecting the illumination beam onto the epitaxial layer or the silicon carbide substrate arranged on the stage, a differential interference optical system disposed on an optical path between the optical source and the objective lens and for converting the incident illumination beam into two sub-beams which interfere each other and for combining the sub-beams reflected by the surface of the silicon carbide substrate or the epitaxial layer to produce an interference beam, and an imaging device for receiving the interference beam exiting the differential interference optical system; and
a processor comprising an image formation means for receiving the output signals from the imaging device to form a differential interference contrast image of the surface of the silicon carbide substrate or the epitaxial layer, and defect detection means for detecting the defect existing in or on the silicon carbide substrate or epitaxial layer using the formed differential interference contrast image.

2. The inspection apparatus of claim 1, wherein said optical source produces the line shaped illumination beam extending along one direction or the illumination beam including a plurality of sub-illumination beams aligned with one direction, and the imaging device comprises a line sensor having a plurality of light receiving elements which are aligned with one line, and wherein said optical apparatus is constructed as a confocal optical apparatus.

3. The inspection apparatus of claim 1, wherein said illumination beam forms an illumination spot having a relative large illumination area on the surface of the silicon carbide substrate or epitaxial layer.

4. The inspection apparatus of claim 3, wherein said imaging device comprises a line sensor or a TDI sensor.

5. The inspection apparatus of claim 1, wherein the optical source produces the illumination beam which has a wavelength of visible range or ultraviolet range.

6. The inspection apparatus of claim 1, wherein said processor further comprises an image memory for storing the differential interference contrast image formed by the image forming means, and an address memory for storing the address of the detected defect.

7. The inspection apparatus of claim 1, wherein during inspection, the stage moves along the first direction and second direction in zigzag fashion so that the surface of the silicon carbide substrate or epitaxial layer is scanned by the illumination beam.

8. An inspection apparatus for detecting a defect existing in or on a silicon carbide substrate or an epitaxial layer formed on the silicon carbide substrate comprising:
an optical apparatus comprising an optical source for producing an illumination beam, a stage for supporting the silicon carbide substrate to be inspected and being movable along a first direction and a second direction perpendicular to the first direction, an objective lens for projecting the illumination beam onto the epitaxial layer or the silicon carbide substrate arranged on the stage, a differential interference optical system disposed on an optical path between the optical source and the objective lens and for converting the incident illumination beam into two sub-beams which interfere each other and for combining the sub-beams reflected by the surface of the silicon carbide substrate or the epitaxial layer to produce an interference beam, and an imaging device for receiving the interference beam exiting the differential interference optical system; and
a processor comprising an image formation means for receiving the output signals from the imaging device to form a differential interference contrast image of the surface of the silicon carbide substrate or epitaxial layer, defect detection means for detecting the defect existing in or on the silicon carbide substrate or epitaxial layer using the formed differential interference contrast image, and defect classification means for classifying the detected defect using the differential interference contrast image of the detected defect.

9. The inspection apparatus of claim 8, wherein said defect classification means comprise classifying means for identifying the defect image of a specific shape and relative large size and classifying such defect as a shape defect including a carrot defect, triangle defect, comet defect and half moon defect.

10. The inspection apparatus of claim 8, wherein said defect classification means comprise classifying means for identifying the defect image having a specific luminance distribution of a high luminance image portion and a low luminance image portion and classifying such defect as a dislocation defect.

11. The inspection apparatus of claim 8, wherein said defect classification means comprise classifying means for identifying the defect image having a spot shaped low luminance image and classifying such defect as a micropipe defect

12. The inspection apparatus of claim 8, wherein said defect classification means comprise classifying means for identifying the defect image having a specific luminance distribution of a high luminance image portion and a low luminance image portion and a direction of the occurrence of the bright and dark image portions which is reverse to that of the dislocation defect and for classifying such defect as a bump defect.

13. The inspection apparatus of claim 8, wherein said processor further comprises an image memory for storing the differential interference contrast image formed by the image forming means and an address memory for storing the address of the detected defect.

14. The inspection apparatus of claim 8, wherein said processor further comprises mapping means producing a map information for assigning to the silicon carbide substrate a plurality of chip sections on which each device is scheduled to be formed, respectively, and defect distribution data producing means for producing defect distribution data showing the class of the detected defect or the class and the number of the detected defects every each chip section using the classification result and the map information.

15. The inspection apparatus of claim 14, wherein said defect distribution data includes an information showing the presence of the killer defect and the number of the dislocation defects every each chip section.

16. The inspection apparatus of claim 8, wherein said optical source produces the line shaped illumination beam extending along one direction or the illumination beam including a plurality of sub-illumination beams aligned with one direction, and the imaging device comprises a line sensor having a plurality of light receiving elements which are arranged along one line, and wherein said optical apparatus is constructed as a confocal optical apparatus.

17. The inspection apparatus of claim 8, wherein said illumination beam forms an illumination spot having a relative large illumination area on the surface of the silicon carbide substrate or epitaxial layer.

18. The inspection apparatus of claim 8, wherein said imaging device comprises a line sensor or a TDI sensor.

19. The inspection apparatus of claim 8, wherein the optical source produces the illumination beam which has a wavelength of visible range or ultraviolet range.

20. An inspection apparatus for detecting a defect existing in or on a silicon carbide substrate or an epitaxial layer formed on the silicon carbide substrate comprising:
a confocal scanning apparatus comprising an optical source for producing a line shaped illumination beam extending along a first direction or an illumination beam including a plurality of sub-illumination beams aligned with one direction, a stage for supporting the silicon carbide substrate to be inspected and being movable along the first direction and a second direction perpendicular to the first direction, an objective lens for projecting the illumination beam onto the epitaxial layer or the silicon carbide substrate arranged on the stage, means for changing a relative distance between the objective and the silicon carbide substrate along the optical axis, and a line sensor having a plurality of light receiving elements aligned with a direction corresponding to the first direction and for receiving reflected light by the surface of the silicon carbide substrate or the epitaxial layer;
a differential interference optical system selectively disposed on an optical path between the optical source and the objective lens and for converting the incident illumination beam into two sub-beams which interfere each other and for combining the sub-beams reflected by the surface of the silicon carbide substrate or the epitaxial layer to produce an interference beam; and
a processor comprising an image formation means for receiving the output signals from the line sensor to form a differential interference contrast image of the surface of the silicon carbide substrate or the epitaxial layer, and defect detection means for detecting the defect existing in or on the silicon carbide substrate or epitaxial layer based on the formed differential interference contrast image, and means for forming a surface contour image of the surface of the silicon carbide substrate or epitaxial using a plurality of confocal images which are captured while changing the relative distance along the optical axis between the objective and the substrate.

21. The inspection apparatus of claim 20, wherein said processor further comprises defect classification means for classifying the defect using the differential interference contrast image of the detected defect.

22. The inspection apparatus of claim 20, wherein said defect classification means for classifying the defect using the differential interference contrast image and the surface contour image of the detected defect.

23. The inspection apparatus of claim 21, wherein said defect classification means comprise means for judging whether the detected defect is the micropipe defect using the surface contour image of the detected defect.

24. The inspection apparatus of claim 20, wherein said defect classification means comprise classifying means for identifying the defect image of a specific shape and relative large size and classifying such defect as a shape defect including a carrot defect, triangle defect, comet defect and half moon defect.

25. The inspection apparatus of claim 20, wherein said defect classification means comprise classifying means for identifying the defect image having a specific luminance distribution of a high luminance image portion and a low luminance image portion and classifying such defect as a dislocation defect.

26. The inspection apparatus of claim 20, wherein said differential interference optical system comprises a Nomarski prism, and wherein said Nomarski prism is disposed on the optical path when the differential interference contrast image being capture and is retracted from the optical path when the confocal image being captured.

27. An inspection apparatus for detecting a defect existing in an epitaxial layer formed on a silicon carbide substrate comprising:
an optical apparatus comprising an optical source for producing an illumination beam, a stage for supporting the silicon carbide substrate and being movable along a first direction and a second direction perpendicular to the first direction, an objective lens for projecting the illumination beam onto the epitaxial layer formed on the silicon carbide substrate arranged on the stage, a differential interference optical system disposed on an optical path between the optical source and the objective lens and for converting the incident illumination beam into two sub-beams which interfere each other and for combining the sub-beams reflected by the surface of the epitaxial layer to produce an interference beam, and an imaging device for receiving the interference beam exiting the differential interference optical system; and
a processor comprising an image formation means for receiving the output signals from the imaging device to form a differential interference contrast image of the surface of the epitaxial layer, and defect detection means for detecting the defect existing in or on the epitaxial layer using the formed differential interference contrast image, wherein
at least one of the rotation angle of the stage or the shearing direction of the differential interference optical system is constructed adjustably, and wherein
the differential interference contrast image in which a step bunching image is optically attenuated or extinct is formed, when the shearing direction of the differential interference optical system is adjusted to be perpendicular to an orientation flat of the substrate or to be parallel to an extending direction of the step bunching formed in the epitaxial layer.

28. The inspection apparatus of claim 27, wherein said inspection apparatus comprises a first inspection mode in which the defects other than the step bunching are mainly detected and a second inspection mode in which the step bunching is mainly detected, and wherein in the first inspection mode the shearing direction of the differential interference optical system is adjusted to be perpendicular to the orientation flat of the substrate or to be parallel to the extending direction of the step bunching, and in the second inspection mode the shearing direction of the differential interference optical system is adjusted not to be perpendicular to the orientation flat of the substrate or not to be parallel to the extending direction of the step bunching.

29. The inspection apparatus of claim 27, wherein said defect detection means comprises a first detection means which detects the defects other than the step bunching and a second detection means which detect the step bunching, and wherein the first detection means comprise means for attenuating the brightness change along the direction parallel to the orientation flat of the substrate or perpendicular to the extending direction of the step bunching, and the second detection means comprise means for enhancing the brightness change along the direction parallel to the orientation flat of the substrate or perpendicular to the extending direction of the step bunching.

30. The inspection apparatus of claim 27, wherein said processor further comprises defect classification means for classifying the defect using the differential interference contrast image of the detected defect.

31. An inspection method for detecting a defect existing in a silicon carbide substrate or an epitaxial layer formed on the silicon carbide substrate using an optical apparatus which comprises an optical source for producing an illumination beam, a stage for supporting the silicon carbide substrate to be inspected, an objective lens for projecting the illumination beam onto the silicon carbide substrate arranged on the stage, a differential interference optical system disposed on an optical path between the optical source and the objective lens, and an imaging device for receiving a reflection beam reflected by the surface of the silicon carbide substrate or the epitaxial layer, comprising the steps of:
scanning the surface of the silicon carbide substrate or the epitaxial layer by the illumination beam;
receiving the reflected light from the surface of the silicon carbide substrate or the epitaxial layer by the imaging device through the objective and the differential interference optical device;
forming the differential interference contrast image of the surface of the silicon carbide substrate or the epitaxial layer;
detecting the defect existing in or on the silicon carbide substrate or the epitaxial layer using the formed differential interference contrast image.

32. An inspection method for detecting a defect existing in a silicon carbide substrate or an epitaxial layer formed on the silicon carbide substrate using an optical apparatus which includes a differential interference optical system, and for classifying the detected defect, comprising the steps of:
scanning the surface of the silicon carbide substrate or the epitaxial layer by the illumination beam to form a differential interference contrast image of the surface of the silicon carbide substrate or the epitaxial layer;
detecting the defect using the formed differential interference contrast image;
classifying the defect using the formed differential interference contrast image of the detected defect.

33. The inspection method of claim 32, wherein said defect classification step includes a classifying step of identifying the defect image having a specific shape and a large size and classifying such defect as a shape defect including a carrot defect, triangle defect, comet defect and half moon defect.

34. The inspection method of claim 32, wherein said defect classification step includes classifying step of identifying the defect image having a specific luminance distribution of a high luminance image portion and a low luminance image portion and classifying such defect as a dislocation defect.

35. The inspection method of claim 32, wherein said defect classification step includes a classifying step of identifying the defect image having a spot shaped low luminance image and classifying such defect as a micropipe defect.

36. The inspection method of claim 32, wherein said defect classification step includes a classifying step of identifying the defect image having a specific luminance distribution of a high luminance image portion and a low luminance image portion and the direction of the occurrence of the bright and dark image portions which is reverse to that of the dislocation defect and classifying such defect as a bump defect.

37. The inspection method of claim 32, wherein said defect classification step includes a first classifying step of judging whether the inputted defect image has a specific shape and a large size and classifying such defect as the shape defect, if so;
a second classifying step of judging whether the defect image which could not be identified at the first classifying step has a specific luminance distribution of a high luminance image portion and a low luminance image portion and classifying such defect as the dislocation defect, if so;
a third classifying step of judging whether the defect image which could not be identified at the first and third classifying steps has the spot shaped low luminance image and classifying such defect as the micropipe defect, if so.

38. The inspection method of claim 32, wherein said inspection method further comprises mapping step of producing a map information for assigning to the silicon carbide substrate a plurality of chip sections on which each device is scheduled to be formed, respectively, and defect distribution data producing step of producing defect distribution data showing the class of the detected defect or the class and the number of the detected defects every each chip section using the classification result and the map information.

39. The inspection method of claim 32, wherein said optical device comprises an optical source for producing an illumination beam, a stage for supporting the silicon carbide substrate to be inspected, an objective lens for projecting the illumination beam onto the silicon carbide substrate arranged on the stage, a differential interference optical system disposed on an optical path between the optical source and the objective lens, and an imaging device for receiving an interference beam emitted from the differential interference optical system.

40. The inspection method of claim 32, wherein said optical source for producing an illumination beam having a wavelength of ultraviolet region which is substantially opaque for the silicon carbide substrate, and wherein the imaging device comprises a line sensor or a TDI sensor.

41. An inspection method for detecting a defect existing in an epitaxial layer formed on a silicon carbide substrate by a step flow growth method using an optical apparatus which includes a differential interference optical system, comprising the steps of:
arranging the silicon carbide substrate on which the epitaxial layer is formed on the stage;
adjusting the rotation angle of the stage or the shearing direction of the differential interference optical system so that the shearing direction of the differential interference optical system is perpendicular to an orientation flat of the substrate or parallel to an extending direction of a step bunching formed in the epitaxial layer;
capturing the surface of the epitaxial layer using the optical apparatus which includes the differential interference optical system to form a differential interference contrast image in which an image of a step bunching is optically attenuated or extinct; and
detecting the defect using the formed differential interference contrast image.

42. The inspection method of claim 41, wherein said inspection method further comprises a step of classifying the defect using the differential interference contrast image of the detected defect.
